(19) United States
(12) Patent Application Publication
(10) Pub. No.: US 2026/0187143 A1
(43) Pub. Date: Jul. 2, 2026

(54) METHOD OF GENERATING SEARCH KEYWORD FOR VIDEO CONTENT, AND ELECTRONIC DEVICE PERFORMING THE METHOD

(71) Applicant: SAMSUNG ELECTRONICS CO., LTD., Suwon-si (KR)

(72) Inventors: Jihoon LEE, Suwon-si (KR); Wonnam JANG, Suwon-si (KR); Daye LEE, Suwon-si (KR); Sejun PARK, Suwon-si (KR); Sungwook PARK, Suwon-si (KR); Sooyeon KIM, Suwon-si (KR)

(73) Assignee: SAMSUNG ELECTRONICS CO., LTD., Suwon-si (KR)

(21) Appl. No.: 19/426,995

(22) Filed: Dec. 19, 2025

Related U.S. Application Data
(63) Continuation of application No. PCT/KR2025/022049, filed on Dec. 17, 2025.

(30) Foreign Application Priority Data
Dec. 31, 2024 (KR) 10-2024-0202485

(51) Int. Cl. G06F 16/735; G06F 3/0482; G06F 16/738; G06V 20/40; G06V 40/16

(52) U.S. Cl. CPC G06F 16/735; G06F 3/0482; G06F 16/738; G06V 20/46; G06V 40/179; G06V 2201/10

(57) ABSTRACT

A method performed by an electronic device is provided. The method includes receiving, from a user, a request to search for content of a video; identifying, among scenes included in the video, a target scene associated with the request; collecting metadata associated with the video; extracting scene information representing the target scene based on the metadata; generating keywords based on the metadata and the scene information; performing a search based on a first keyword among the keywords; and controlling a display to display a keyword search user interface (UI), the keyword search UI including a search result UI element that represents a result of the search based on the first keyword.

### CROSS-REFERENCE TO RELATED APPLICATION(S)

This application is a bypass continuation application of International Patent Application No. PCT/KR2025/022049, filed on Dec. 17, 2025, which claims priority to and is based on Korean Patent Application No. 10-2024-0202485, filed on Dec. 31, 2024, the disclosures of which are incorporated herein in their entireties by reference.

### BACKGROUND

### 1. Field

One or more embodiments of the present disclosure relate to a method performed by an electronic device including a display, and more particularly, to a method of generating search keywords for video content and an electronic device performing the method.

### 2. Description of Related Art

Electronic devices including a display may reproduce images in various environments. For example, electronic devices such as televisions may provide information or entertainment to users through video content. Users may want detailed information about specific scenes, people, products, places, etc. shown in videos. Users may need this detailed information to purchase related products, gain deep knowledge about content, or satisfy curiosity. However, users may have to use separate devices (e.g., smartphones) or go through multiple steps using such devices in order to obtain such information. Searching and analyzing video content provided by display devices can be improved to enrich user experience and enhance interaction between users and the devices.

### SUMMARY

According to an aspect of one or more embodiments of the present disclosure, A method performed by an electronic device may include receiving, from a user, a request to search for content of a video; identifying, among a plurality of scenes included in the video, a target scene associated with the request; collecting metadata associated with the video; extracting scene information representing the target scene based on the metadata; generating one or more keywords based on the metadata and the scene information; performing a search based on a first keyword among the one or more keywords; and controlling a display to display a keyword search user interface (UI), the keyword search UI including a search result UI element that represents a result of the search based on the first keyword.

The key search UI may further include a keyword list UI element representing the one or more keywords.

The method may further include obtaining, from the user, an input for selecting a second keyword among the one or more keywords; and modifying the search result UI element to represent an updated result of the search based on the second keyword.

The method of identifying of the target scene may include extracting one or more still cuts from the stored copy; displaying, within the keyword search UI a still cut UI element representing the one or more still cuts and a selection UI element for selecting one still cut from among the one or more still cuts; obtaining, from the user, an input instructing to select a first still cut; and identifying a scene corresponding to the first still cut among the one or more still cuts as the target scene.

The method of identifying the target scene may include extracting one or more still cuts from the stored copy; transmitting the one or more still cuts to a user terminal; receiving, from the terminal, selection of a second still cut among the one or more still cuts; and identifying the second still cut as the target scene.

The method of identifying the target scene may include identifying a scene displayed at a time point when the request for searching for the content of the video is received as the target scene.

The method of collecting the metadata may include analyzing an electronic program guide (EPG) associated with the video; analyzing one or more overlays included in the content of the video from the target scene; collecting information about the video based on the one or more overlays; and performing a search for the content of the video.

The method of extracting the scene information may include inputting the target scene to a vision-language model (VLM); and obtaining scene description information for the target scene from the VLM.

The method of extracting the scene information may include performing automatic speech recognition (ASR) with respect to a first section of the video including the target scene; and obtaining text data corresponding to voice data included in the first section based on the performing the ASR.

The method of extracting the scene information may include detecting one or more objects from the target scene; and obtaining a list of the one or more objects based on the detection of the one or more objects.

The method of extracting the scene information may include recognizing one or more faces included in the target scene based on the metadata; and obtaining information about the one or more faces.

The method of generating the one or more keywords may include inputting the metadata and the scene information to a language model; and obtaining the one or more keywords from the language model.

The method may further include transmitting the one or more keywords to a user terminal.

According to an aspect of one or more embodiments of the present disclosure, a non-transitory computer-readable storage medium having stored thereon instructions that, when executed by a processor, may cause the processor to receive, from a user, a request to search for content of a video; identify, from among a plurality of scenes included in the video, a target scene associated with the request; collect metadata associated with the video; extract scene information representing the target scene based on the metadata; generate one or more keywords based on the metadata and the scene information; perform a search based on a first keyword among the one or more keywords; and control a display to display a keyword search user interface (UI), the keyword search UI comprising a search result UI element that represents a result of the search based on the first keyword.

According to an aspect of one or more embodiments of the present disclosure, an electronic device may include at least one processor; memory storing one or more instructions; a communication interface configured to perform communication with an external device; and a display configured to display a video. The one or more instructions, when executed by the at least one processor individually or collectively, may cause the electronic device to receive, from a user, a request to search for content of a video; identify, from among a plurality of scenes included in the video, a target scene associated with the request; collect metadata associated with the video; extract scene information representing the target scene based on the metadata; generate one or more keywords based on the metadata and the scene information; perform a search based on a first keyword among the one or more keywords; and control a display to display a keyword search user interface (UI), the keyword search user interface (UI) comprising a search result UI element that represents a result of the search based on the first keyword.

The one or more instructions, when executed by the at least one processor individually or collectively, may further cause the electronic device to obtain, from the user, an input for selecting a second keyword among the one or more keywords; and modify the search result UI element to represent an updated result of the search based on the second keyword.

The one or more instructions, when executed by the at least one processor individually or collectively, may further cause the electronic device to analyze an electronic program guide (EPG) associated with the video; analyze one or more overlays included in the content of the video from the target scene; based on the one or more overlays, collect information about the video; and perform a search for the content of the video.

The one or more instructions, when executed by the at least one processor individually or collectively, may further cause the electronic device to obtain scene description information for the target scene by inputting the target scene to a vision-language model (VLM); obtain text data corresponding to voice data included in a first section of the video including the target scene based on performance of automatic speech recognition (ASR) with respect to the first section; detect one or more objects from the target scene; and recognize one or more faces included in the target scene based on the metadata.

The one or more instructions, when executed by the at least one processor individually or collectively, may further cause the electronic device to input the metadata and the scene information to a language model; and obtain the one or more keywords from the language model.

The one or more instructions, when executed by the at least one processor individually or collectively, may further cause the electronic device to transmit the one or more keywords to a user terminal via the communication interface.

### BRIEF DESCRIPTION OF DRAWINGS

The above and other aspects, features, and advantages of one or more embodiments of the present disclosure will be more apparent from the following description taken in conjunction with the accompanying drawings, in which:

FIG. 1 illustrates an exemplary operation for generating one or more keywords in response to a search for content of a video displayed on an electronic device, according to one or more embodiments of the present disclosure;

FIG. 2 illustrates a user interface (UI) displayed on an electronic device, according to one or more embodiments of the present disclosure;

FIG. 3 is a block diagram of an electronic device according to an embodiment of one or more embodiments of the present disclosure;

FIG. 4 is a flowchart of a method performed by an electronic device, according to one or more embodiments of the present disclosure;

FIG. 5 illustrates exemplary operations for selecting a target scene, according to one or more embodiments of the present disclosure;

FIG. 6 is a block diagram illustrating exemplary operations for collecting metadata and exemplary operations for obtaining scene information, according to one or more embodiments of the present disclosure;

FIG. 7 illustrates an exemplary operation for obtaining scene information, according to one or more embodiments of the present disclosure;

FIGS. 8A and 8B are block diagrams illustrating an operation of generating one or more keywords, according to one or more embodiments of the present disclosure;

FIGS. 9A and 9B are block diagrams illustrating an operation of performing a search based on a first keyword, according to one or more embodiments of the present disclosure;

FIGS. 10A through 10C illustrate exemplary UIs that may be displayed by an electronic device, according to one or more embodiments of the present disclosure;

FIG. 11 illustrates an exemplary operation of receiving a content search request from a user via a remote controller, according to one or more embodiments of the present disclosure;

FIG. 12 is a block diagram of a user terminal that communicates with an electronic device, according to one or more embodiments of the present disclosure;

FIG. 13 illustrates exemplary UIs that may be displayed by a user terminal, according to one or more embodiments of the present disclosure; and

FIG. 14 is a block diagram of a server that communicates with an electronic device, according to one or more embodiments of the present disclosure.

### DETAILED DESCRIPTION

Terms defined herein may be used for only describing a specific embodiments and may not limit the scope of one or more embodiments of the present disclosure. An expression used in the singular may encompass the expression of the plural, unless it has a clearly different meaning in the context. Unless otherwise defined, all terms (including technical and scientific terms) used herein may have the same meaning as commonly understood by one of ordinary skill in the art corresponding to one or more embodiments of the present disclosure. It will be further understood that terms defined in commonly used dictionaries among the terms used herein should be interpreted as having meanings that are the same as or similar to their meaning in the context of the relevant art and may not be interpreted in an idealized or overly formal sense unless expressly so defined herein. In some case, terms defined herein cannot be interpreted to exclude one or more embodiments of the present disclosure.

In one or more embodiments of the present disclosure one or more methods may be performed by hardware (e.g., processor). However, some embodiments can be purely or partially software-based.

An expression used in the singular may encompass the expression of the plural, unless it has a clearly different meaning in the context. Unless otherwise defined, all terms (including technical and scientific terms) used herein have the same meaning as commonly understood by one of ordinary skill in the art to which this disclosure belongs.

The terms such as “comprising,” “having,” “including,” and “containing” are to be construed as open-ended terms (meaning “including, but not limited to,”) unless otherwise noted. The terms may specify the presence of stated features, numbers, steps, operations, elements, components or combinations thereof. The terms may not preclude the possibility of the presence or addition of one or more other features, numbers, steps, operations, elements, components, and/or combinations thereof. Recitation of ranges of values herein are merely intended to serve as a shorthand method of referring individually to each separate value falling within range, unless otherwise indicated herein and each separate value is incorporated into specification as if it were individually recited herein.

Unless explicitly described or implicitly understood from one or more embodiments of the present disclosure, at least one of the components, elements, modules or units, or any nominalized verbs (collectively “components” in this paragraph) represented by a block or an equivalent indication in the drawings may be implemented or embodied by analog and/or digital circuits including one or more of a logic gate, an integrated circuit, a microprocessor, a microcontroller, a memory circuit, a passive electronic component, an active electronic component, an optical component, and the like. Alternatively or additionally, these components may be implemented or embodied by software including one or more instructions stored in an internal or external storage medium that is readable by at least one processor. For example, the at least one processor may invoke at least one of the one or more instructions stored in the storage medium, and execute it, with or without using one or more other components under the control of the at least one processor. This allows the at least one processor to perform at least one function or operation described above as being performed by each of the components according to the at least one instruction invoked. Here, the at least one processor may include a central processing unit (CPU), a graphic processing unit (GPU), another type of microprocessor, not being limited thereto. In other examples, the at least one processor may be implemented in application specific integrated circuit (ASIC) and field-programmable gate array (FPGA).

The expression “configured to (or set to)” used herein may be used interchangeably with, for example, “suitable for”, “having the capacity to”, “designed to”, “adapted to”, “made to”, or “capable of”, according to situations. The expression “configured to (or set to)” may not only necessarily refer to “specifically designed to” in terms of hardware. Instead, in some situations, the expression “system configured to” may refer to a situation in which the system is “capable of” together with another device or component parts. For example, the phrase “a processor configured (or set) to perform A, B, and C” may refer to a dedicated processor (such as an embedded processor) for performing a corresponding operation, or a generic-purpose processor that can perform a corresponding operation by executing one or more software programs stored in a memory.

It will be understood that when an element or layer is referred to as being “on,” “connected to” or “coupled to” another element or layer, it can be directly on, connected or coupled to the other element or layer, or intervening elements or layers may be present. By contrast, when an element is referred to as being “directly on,” “directly connected to,” or “directly coupled to” another element or layer, there are no intervening elements or layers present.

In the disclosure, expressions of more than or less than may be used to determine whether a specific condition is satisfied or fulfilled, but this is only a description for expressing an example and does not exclude descriptions of no less than or no more than. Conditions written as ‘no less than’ may be replaced with ‘more than’, conditions written as ‘no more than’ may be replaced with ‘less than’, and conditions written as ‘no less than and less than’ may be replaced with ‘more than and no more than’.

Use of terms such as “a” and “an” and “the” and similar referents in context of describing disclosed embodiments (especially in context of following claims) are to be construed to cover both singular and plural, unless otherwise indicated herein or clearly contradicted by context, and not as a definition of a term. Number of items in a plurality is at least two, but can be more when so indicated either explicitly or by context.

Conjunctive language, such as phrases of form “at least one of A, B, and C,” or “at least one of A, B or C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B or C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items).

Further, unless stated otherwise or otherwise clear from context, phrase “based on” means “based at least in part on” and not “based solely on.”

In one or more embodiments of the present disclosure, ‘video’ may refer to data including an object that moves over time. For example, video may include one or more consecutive image frames. According to one or more embodiments of the present disclosure, the video may further include audio data such as a voice or music.

In one or more embodiments of the present disclosure, a ‘target scene’ may refer to a scene that is the target of a content search request received from a user. For example, the ‘target scene’ may refer to a scene that is the target of a content search, among one or more scenes included in a video. In one or more embodiments of the present disclosure, the ‘target scene’ may refer to a frame for performing a content search, among the one or more scenes included in the video. In one or more embodiments of the present disclosure, the target scene may be a set of consecutive frames included in the video. For example, the target scene may be a set of consecutive frames that share a temporal or spatial background.

In one or more embodiments of the present disclosure, a ‘keyword’ may refer to a word or phrase that includes information about at least one of a search target object, an action, a behavior, a situation, or an event that a user wishes to search for. For example, a keyword may be referred to as a search word or a query word.

In one or more embodiments of the present disclosure, metadata of a video may refer to attributes of the video, context, and/or descriptive information for describing content. For example, the metadata of the video may include information about a program (e.g., various audiovisual programs such as movies, dramas, or television shows) including the video (e.g., the title of the program, the title and episode number of an episode in the program including the video, the year of production, the genre, the director, the producer, the filming location, the distributor, the release platform, the subtitle/audio language or locality, or the copyright or license, or the summary of the episode including the video) and information about various items or things included in the video, such as the roles, actors, soundtracks, props, and locations included in the video.

In one or more embodiments of the present disclosure, an ‘artificial intelligence (AI) model’ may refer to a model composed of a plurality of neural network layers. Each of the plurality of neural network layers may have a plurality of weight values. Each of the plurality of neural network layers may perform a neural network operation through an operation between an operation result of a previous layer and the plurality of weight values. The plurality of weight values of the plurality of neural network layers may be optimized by a learning result of the AI model. For example, the plurality of weight values may be updated so that a loss value or a cost value obtained from the AI model is reduced or minimized during a learning process. The AI model may include a deep neural network (DNN). For example, the AI model may be based on various neural networks such as a Convolutional Neural Network (CNN), a Recurrent Neural Network (RNN), a Restricted Boltzmann Machine, a Deep Belief Network, a Bidirectional Recurrent Deep Neural Network, transformer neural networks or Deep Q-Networks. However, one or more embodiments of the present disclosure are not limited to the above-described examples.

In one or more embodiments of the present disclosure, functions related to AI may be operated through a processor and memory. The processor may include one processor or a plurality of processors. The one or plurality of processors may be a general-purpose processor (e.g., central processing unit (CPU)), a dedicated graphics processor (e.g., graphics processing unit (GPU)), or a dedicated AI processor (e.g., tensor processing unit (TPU)). The one or plurality of processors may process input data according to a predefined operation rule or AI model stored in the memory. According to one or more embodiments of the present disclosure, when the one or plurality of processors are AI-only processors, the AI-only processors may be designed in a hardware structure specialized for processing a specific AI model.

The predefined operation rule or AI model is created through learning. Here, being created through learning may refer to training a basic AI model using a plurality of training data by a learning algorithm, so that a predefined operation rule or AI model set to perform desired characteristics (or a desired purpose) is created. Such learning may be performed in a device itself on which AI according to the one or more embodiments of the present disclosure is performed, or may be performed through a separate server and/or system. Examples of the learning algorithm may include, but are not limited to, supervised learning, unsupervised learning, semi-supervised learning, reinforcement learning, or fine-tuning (e.g., parameter efficient fine tuning (PEFT)).

In the present disclosure, a ‘language model (LM)’ may refer to an AI model designed for natural language processing (NLP), such as language understanding or language generation. For example, the language model may be understood as an AI model trained to generate an output in the form of natural language in response to input data. The language model may be an AI model trained to generate and output natural language descriptions of input images by using technology. According to one or more embodiments of the present disclosure, the language model may be a monomodal or unimodal model trained to process a single type of input (e.g., a text input, an image input, or an audio input). According to one or more embodiments of the present disclosure, the language model may be a multimodal model trained to process a plurality of types of inputs.

Embodiments of the present disclosure will now be described in detail herein with reference to the accompanying drawings so that the embodiments of the present disclosure may be easily performed by one of ordinary skill in the art to which the present disclosure pertains. The present disclosure may, however, be embodied in many different forms and should not be construed as being limited to the embodiments set forth herein.

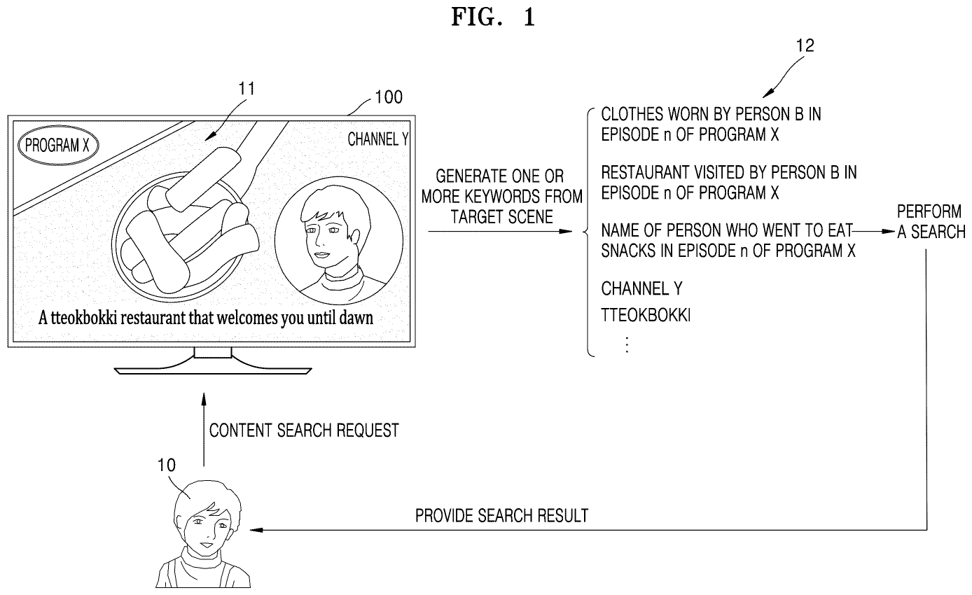

FIG. 1 illustrates an exemplary operation for generating one or more keywords in response to a search for content of a video displayed on an electronic device 100, according to one or more embodiments of the present disclosure.

Referring to FIG. 1, the electronic device 100 may display a video. For example, the electronic device 100 may display a video including a first scene 11. A user 10 of the electronic device 100 may view the video displayed on the electronic device 100. The electronic device 100 may receive a content search request for the video from the user 10. The electronic device 100 may identify a target scene corresponding to the received content search request. The electronic device 100 may generate one or more keywords from the target scene. The electronic device 100 may perform search, based on at least one of the generated one or more keywords. The electronic device 100 may provide a result of the search to the user 10.

The electronic device 100 may receive, from the user 10, a request for searching for content included in the video. According to one or more embodiments of the present disclosure, the electronic device 100 may be connected to various forms of user controllers, such as a remote controller, a user terminal, user equipment, or a game pad. The electronic device 100 may receive, from the user 10 through a user controller, the request for searching for the content included in the video.

According to one or more embodiments of the present disclosure, there may be, on the user controller, a button that commands a content search. In response to obtaining the user 10′ input for the button commanding a content search, the user controller may transmit, to the electronic device 100, the request for searching for the content included in the video.

According to one or more embodiments of the present disclosure, the user controller may include a display. A user interface (UI) element (e.g., a graphical UI (GUI) such as an icon) for commanding content search may be displayed on the display of the user controller. In response to obtaining the input from the user 10 for the UI element for commanding a content search, the user controller may transmit, to the electronic device 100, the request for searching for the content included in the video.

According to one or more embodiments of the present disclosure, the electronic device 100 may display the UI element for directing content search. Under control by the user 10, the user controller may transmit, to the electronic device 100, an input for the UI element for commanding a content search displayed on the electronic device 100. The input from the user controller for the UI element commanding a content search may correspond to the request for searching for the content included in the video being displayed on the electronic device 100. In response to the input from the user controller for the UI element commanding a content search, the electronic device 100 may obtain (or receive) the request for searching for the content included in the video.

The electronic device 100 may identify (or determine) a target scene (or a target frame) corresponding to the request for content search from the user 10 among the scenes (or frames) included in the video being displayed by the electronic device 100. According to one or more embodiments of the present disclosure, the electronic device 100 may identify a scene (or a frame) of the video displayed by the electronic device 100 as the target scene at a time point when the request for content search is received from the user 10. According to one or more embodiments of the present disclosure, the electronic device 100 may request the user 10 for an input for the target scene. Based on the input for the target scene from the user 10, the electronic device 100 may identify the target scene.

The electronic device 100 may collect information related to the target scene. For example, the electronic device 100 may collect metadata of the video including the target scene. Based the metadata of the video, the electronic device 100 may analyze the target scene. For example, the electronic device 100 may obtain scene information representing the target scene, by analyzing the target scene. The scene information may include various pieces of information for representing the target scene, such as scene description information describing the target scene, voice information describing voices included in the target scene, a list of objects included in the target scene, or character information indicating characters included in the target scene.

Based the collected metadata and the scene information, the electronic device 100 may generate one or more keywords from the target scene. According to one or more embodiments of the present disclosure, the electronic device 100 may use at least one of various language models, such as a large language model (LLM) or a vision-language model. The electronic device 100 may input the collected metadata and the scene information to a language model. The electronic device 100 may obtain the one or more keywords from the language model.

For example, in the embodiment illustrated in FIG. 1, the electronic device 100 may identify a first scene 11 as the target scene associated with a content search request from the user 10. The electronic device 100 may collect metadata about the first scene 11, including information indicating that a video including the first scene 11 corresponds to an episode n of program A and information about the character name or real name (e.g., an actor's name) of a person appearing in the first scene 11. Based the collected metadata, the electronic device 100 may analyze the first scene 11. For example, the electronic device 100 may analyze and obtain scene information about the first scene 11, such as a description of the first scene 11, a voice recognition result for the first scene 11, a list of objects included in the first scene 11, or a face recognition result of the people included in the first scene 11.

Based the metadata and scene information about the first scene 11, the electronic device 100 may generate one or more keywords 12. For example, the electronic device 100 may input the metadata and scene information about the first scene 11 to the language model. When the metadata and scene information regarding the first scene 11 are given, the electronic device 100 may input, to the language model, a query or input prompt of instructing the language model to output one or more keywords for searching for the first scene 11. One or more keywords 12 regarding the first scene 11 may be output by the language model. For example, the one or more keywords 12 regarding the first scene 11 may include one or more search keywords that are predicted to be searched or queried regarding the first scene 11 by the user 10, such as ‘clothes worn by person B in episode n of program A’, ‘a restaurant visited by person B in episode n of program A’, ‘the name of a person who went to eat snacks in episode n of program A’, ‘channel Y’, or ‘tteokbokki’.

Based on the generated one or more keywords, the electronic device 100 may perform search. The electronic device 100 may select one keyword from the generated one or more keywords. The electronic device 100 may perform search by using the selected keyword. The electronic device 100 may provide a result of the search to the user 10. According to one or more embodiments of the present disclosure, the electronic device 100 may display a UI including a UI element representing (or including and indicating) the result of the search.

According to one or more embodiments of the present disclosure, in response to a content search request from a user, the electronic device 100 may automatically generate search keywords or query words, perform a search by using any one of the generated search keywords, and provide the search result to the user. Accordingly, with just one input for content search, the user may immediately obtain the search result for a video of the electronic device 100 without using a separate user terminal or a separate application. Therefore, user experiences may be improved.

According to one or more embodiments of the present disclosure, searching and analyzing video content provided by display devices can be improved so that users may not have to use separate devices or go through multiple steps using such devices in order to obtain search results. Subsequently, user experience is enriched and interaction between users and the devices are enhanced.

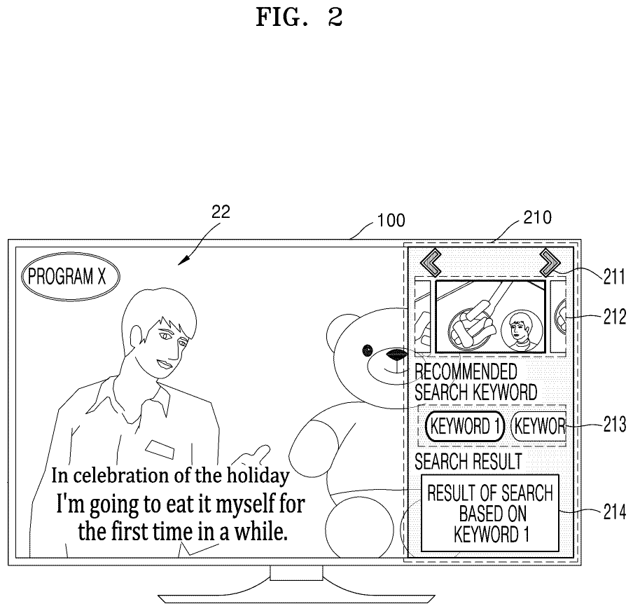

FIG. 2 illustrates a UI displayed on the electronic device 100, according to one or more embodiments of the present disclosure.

Referring to FIG. 2, in response to a content search request from the user 10 of FIG. 1, the electronic device 100 of FIG. 1 may display a keyword search UI 210 for providing a response to the content search request of the user 10. The keyword search UI 210 may include at least one of a scene selection UI element 211, a still cut UI element 212, a keyword list UI element 213, or a search result UI element 214.

The scene selection UI element 211 may include one or more icons for requesting the user 10 to select the target scene. For example, in the embodiment illustrated in FIG. 2, the scene selection UI element 211 may include two arrows, pointing in opposite directions, for receiving (or obtaining or inducing) an input for one among one or more still cuts at least partially included (or shown) in the still cut UI element 212. In response to the user 10's input for a left-direction arrow (e.g., a user's input via a user controller), the electronic device 100 may identify a still cut located on the left side of a current target scene of the still cut UI element 212 as a new target scene. In response to an input of the user 10 for a right-direction arrow (e.g., a user's input via a user controller), the electronic device 100 may identify a still cut located on the right side of the current target scene of the still cut UI element 212 as a new target scene.

The still cut UI element 212 may represent (or include) one or more still cuts extracted from a video. The still cut UI element 212 may at least partially display the one or more still cuts. According to one or more embodiments of the present disclosure, the electronic device 100 may temporarily record (or store) a copy of at least a portion of the video. The electronic device 100 may record a copy of a predefined time length of the video that is displayed. For example, the electronic device 100 may temporarily store a copy of from a current scene (or frame) of the video to a scene a predefined time (e.g., 10 seconds) prior to the current scene. In response to a content search request from the user 10, the electronic device 100 may extract one or more still cuts from the recorded copy. The extracted one or more still cuts may be provided to the user 10 via the still cut UI element 212.

In response to an input of pointing a left direction from the user 10 on the still cut UI element 212, the electronic device 100 may display a still cut located on the left side of a still cut located at the center of the still cut UI element 212 on the center of the still cut UI element 212. In response to an input of pointing a right direction from the user 10 on the still cut UI element 212, the electronic device 100 may display a still cut located on the right side of the still cut located at the center of the still cut UI element 212 on the center of the still cut UI element 212. Accordingly, the still cut displayed on the center of the still cut UI element 212 may be changed in response to the input of the user 10. The electronic device 100 may receive a selection of the target scene from the user 10. The electronic device 100 may identify a scene corresponding to the still cut displayed on the center of the still cut UI element 212 as the target scene at the time point when the selection of the target scene is received from the user 10.

According to one or more embodiments of the present disclosure, the still cut UI element 212 may include a UI element (e.g., a bold border GUI element) for highlighting the scene (or a still cut associated with the scene) identified as the current target scene by the electronic device 100. Through this UI element, the electronic device 100 may inform the user 10 of the current target scene.

According to one or more embodiments of the present disclosure, the scene selection UI element 211 may be displayed on the still cut UI element 212. For example, the scene selection UI element 211 may be displayed around a still cut corresponding to the current target scene, which is included in the still cut UI element 212. A left-pointing arrow icon may be displayed on the left side of the still cut corresponding to the current target scene. A right-pointing arrow icon may be displayed on the right side of the still cut corresponding to the current target scene.

The keyword list UI element 213 may represent a list of one or more keywords generated from the current target scene. For example, the keyword list UI element 213 may represent (or include) at least some of the one or more keywords generated from the current target scene. In the embodiment of FIG. 2, the keyword list UI element 213 may express the entirety of ‘keyword 1’ and a portion of keyword 2.

According to one or more embodiments of the present disclosure, the keyword list UI element 213 may include a UI element (e.g., a bold border GUI element) for highlighting a keyword currently searched by the electronic device 100. Through this UI element, the electronic device 100 may inform the user 10 of the currently searched keyword.

According to one or more embodiments of the present disclosure, the keyword list UI element 213 may represent a summary of keyword 1, instead of the keyword 1 itself. For example, for a keyword ‘clothes worn by person B in episode n of program A’ among the one or more keywords 12 of FIG. 1, a portion of the keyword or a summary of the keyword, such as ‘clothes worn by person B’, instead of the entire keyword, may be provided to the user 10 through the keyword list UI element 213.

The search result UI element 214 may represent (or include) a result of a search based on a keyword currently selected by the electronic device 100. For example, in one or more embodiments illustrated in FIG. 2, the electronic device 100 may select ‘keyword 1’, and may perform a search, based on ‘keyword 1’. The electronic device 100 may display a result of the search performed based on ‘keyword 1’, on the search result UI element 214.

According to one or more embodiments of the present disclosure, the electronic device 100 may input, to a language model, the result of the search performed based on ‘keyword 1’. The language model may generate a natural language output representing the result of the search performed based on ‘keyword 1’. For example, the language model may generate a summary about the result of the search performed based on ‘keyword 1’. The electronic device 100 may display an output of the language model on the search result UI element 214.

According to one or more embodiments of the present disclosure, the electronic device 100 may perform a search based on ‘keyword 1’ by inputting ‘keyword 1’ to a language model including a search engine. For example, the language model may perform the search based on ‘keyword 1’, and generate a natural language output representing the result of the search based on ‘keyword 1’. The electronic device 100 may display an output of the language model on the search result UI element 214.

According to one or more embodiments of the present disclosure, the keyword search UI 210 (or at least some of the UI elements included in the keyword search UI 210) may be at least partially transparent or translucent. According to one or more embodiments of the present disclosure, the keyword search UI 210 may at least partially overlap the video. For example, in the embodiment of FIG. 2, the keyword search UI 210 may at least partially overlap a right portion of the video. However, a location of the keyword search UI 210 is not limited to the embodiment illustrated in FIG. 2. For example, the keyword search UI 210 may be located on any other locations (e.g., a left portion, top, center, bottom) of the electronic device 100.

Referring to embodiments illustrated in FIGS. 1 and 2, in response to the content search request from the user 10, the electronic device 100 may identify a target scene that is the object of the request, generate one or more keywords from the target scene, perform a search based on the extracted keywords, and provide a result of the search to the user 10. Accordingly, the user 10 may obtain the result of the search for a scene currently being viewed, with a single input (e.g., an input of commanding a content search request). Therefore, accessibility of searching for a video displayed on the electronic device 100 may be improved.

In response to a content search request from the user 10, the electronic device 100 may identify the target scene that is the object of the request, without interrupting the video. For example, the electronic device 100 may display the keyword search UI 210, without interrupting the video. For example, at a time point when the first scene 11 of FIG. 1 is displayed, the electronic device 100 may receive a content search request from the user 10. The electronic device 100 may display a second scene 22 of FIG. 2 without interrupting the video, and at the same time may provide a search result based on a keyword extracted from the first scene 11 to the user 10 through the keyword search UI 210. Accordingly, the viewing experience of the user 10 may be prevented from being impaired.

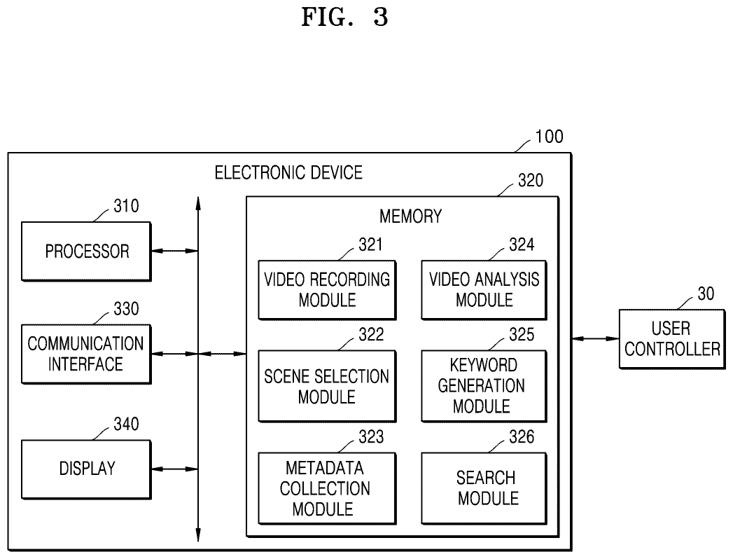

FIG. 3 is a block diagram of the electronic device 100 according to one or more embodiments of the present disclosure.

Referring to FIG. 3, the electronic device 100 may include a processor 310, a memory 320, a communication interface 330, and a display 340. The components included in the electronic device 100 may not be limited to those shown in FIG. 3. For example, one or more of the components illustrated in FIG. 3 may be deleted or changed, or the components not illustrated in FIG. 3 may be added to the electronic device 100.

The electronic device 100 may be a device capable of displaying an image or video data at a user's request. For example, the electronic device 100 may display a video, based on control by the user through a user controller 30. For example, the electronic device 100 may be controlled by the user controller 30, based on various forms of communication protocols (or connectivity), such as infrared (IR), Bluetooth (BT), or Wi-Fi. Additionally or alternatively, the electronic device 100 may further include a UI, such as a physical button on the surface, and may be controlled by a user through the UI.

According to one or more embodiments of the present disclosure, the electronic device 100 may include, without limitation, a television (TV), a settop box, a mobile phone, a tablet personal computer (PC), a digital camera, a camcorder, a laptop computer, a desktop computer, an e-book terminal, a digital broadcast terminal, personal digital assistants (PDAs), a portable multimedia player (PMP), a navigation device, an MP3 player, or a wearable device. According to one or more embodiments of the present disclosure, the electronic device 100 may include a fixed electronic device placed at a fixed location or a movable electronic device having a portable form. According to one or more embodiments of the present disclosure, the electronic device 100 may include a digital broadcast receiver capable of digital broadcasting reception.

The processor 310 may control overall operations of the electronic device 100. For example, the processor 310 may control the electronic device 100 to perform at least some of the operations according to one or more embodiments of the present disclosure. The processor 310 may write data to and read data from the memory 320. For example, the processor 310 may execute one or more instructions of a program stored in the memory 320.

The processor 310 is illustrated as a single element in FIG. 3, but embodiments of the disclosure are not limited thereto. According to one or more embodiments of the present disclosure, the processor 310 may be configured with a plurality of elements. The processor 310 may be a general-purpose processor such as a central processing unit (CPU), an application processor (AP), or a digital signal processor (DSP), a graphics-only processor such as a graphics processing unit (GPU) or a vision processing unit (VPU), or an artificial intelligence (AI)-only processor such as a neural processing unit (NPU).

The processor 310 may include various processing circuitry and/or a plurality of processors. According to the disclosure, a ‘processor’ may include at least one processor, and additionally or alternatively, may include various processing circuitry. The one or more processors may be configured to perform the various functions described above in the disclosure individually and/or collectively in a distributed fashion. As used herein, “a processor”, “at least one processor”, and “one or more processors” may be configured to perform several functions. However, these terms may cover, but are not limited to, a situation where one processor performs some of the functions and other processor(s) perform others of the functions, and a situation where a single processor is capable of performing all of the functions. In addition, the at least one processor may include a combination of processors that perform various functions of the functions disclosed in a distributed manner. The at least one processor may individually and/or collectively execute program instructions in order to accomplish or perform various functions.

The memory 320 may store instructions, a data structure, and program code readable by the processor 310. For example, the memory 320 may store data such as a basic program, an application program, and configuration data for an operation of the electronic device 100. According to one or more embodiments of the present disclosure, the memory 320 may store instructions that may be individually or collectively executed by the processor 310 to cause the electronic device 100 to perform at least some of the operations of the electronic device 100 according to embodiments of the disclosure. For example, the processor 310 may identify a target scene in response to a content search request from a user by executing one or more instructions or codes stored in the memory 320. The processor 310 may obtain metadata and scene information associated with the target scene by executing the one or more instructions or codes stored in the memory 320. The processor 310 may generate one or more keywords based on the metadata and the scene information by executing the one or more instructions or codes stored in the memory 320. The processor 310 may perform a search using the generated one or more keywords by executing the one or more instructions or codes stored in the memory 320.

The memory 320 may include at least one of a flash memory type memory, a hard disk type memory, a multimedia card micro type memory, or a card type memory. For example, the memory 320 may include one or more non-volatile memories (or storage media) such as read-only memory (ROM), electrically erasable programmable read-only memory (EEPROM), programmable read-only memory (PROM), a solid-state drive (SSD), a hard disk drive (HDD), non-volatile random access memory (NVRAM), magnetoresistive RAM (MRAM), ferroelectric RAM (FRAM), optical discs, or a phase-change memory (PCM). The memory 320 may include volatile memory (or storage media) such as a dynamic RAM (DRAM) or a static RAM (SRAM).

The memory 320 may store (or load) instructions, an algorithm, a data structure, or program code related to a video recording module 321, a scene selection module 322, a metadata collection module 323, a video analysis module 324, a keyword generation module 325, and a search module 326. According to one or more embodiments of the present disclosure, a ‘module’ included in the memory 320 may refer to a unit in which a function or operation performed by the processor 120 is processed, and may be implemented as software, such as instructions, an algorithm, a data structure, or program code.

The video recording module 321 may be implemented as instructions or program code for executing functions and/or operations for recording (or storing or videotaping) at least a portion of a video displayed through the display 340 and managing the recorded video. According to one or more embodiments of the present disclosure, the video recording module 321 may store a copy of the portion of the video displayed through the display 340. For example, the video recording module 321 may be configured to temporarily or provisionally store copies of a predefined number or a predefined time interval of most recent frames from a frame currently being displayed on the display 340. The processor 310 may store a portion of a copy of the video played back through the display 340, by executing the instructions or program code of the video recording module 321.

The scene selection module 322 may be implemented as instructions or program code for executing functions and/or operations for identifying a target scene associated with the content search request from the user. According to one or more embodiments of the present disclosure, the scene selection module 322 may be configured to obtain the copy stored by the video recording module 321, extract one or more still cuts from the copy, and request the user to select a still cut associated with the target scene from among the extracted still cuts. According to one or more embodiments of the present disclosure, the scene selection module 322 may identify, as the target scene, a scene displayed by the display 340 at a time point when the content search request is received from the user (e.g., a scene corresponding to the frame displayed by the display 340 at the time point when the content search request is received from the user). According to one or more embodiments of the present disclosure, the scene selection module 322 may be configured to obtain an instruction for a still cut selected by the user and identify a target scene based on the selected still cut. The processor 310 may identify a target scene associated with the content search request from the user by executing the instructions or program code of the scene selection module 322.

The metadata collection module 323 may be implemented as instructions or program code for executing functions and/or operations for collecting information associated with the video displayed through the display 340. According to one or more embodiments of the present disclosure, the metadata collection module 323 may be configured to collect information associated with a video currently being played back through the display 340 (e.g., a video displayed by the display 340 at the time point when the content search request is received from the user). The processor 310 may collect various fields of information associated with the video played back through the display 340, by executing the instructions or program code of the metadata collection module 323.

The video analysis module 324 may be implemented as instructions or program code for executing functions and/or operations for analyzing content of the video displayed through the display 340 and obtaining scene information describing the target scene. According to one or more embodiments of the present disclosure, the video analysis module 324 may be configured to analyze visual and auditory content included in the target scene identified by the scene selection module 322. For example, the video analysis module 324 may analyze visual content, auditory content, context, and/or a narrative included in the target scene. The processor 310 may analyze the content of the target scene from various angles, by executing the instructions or program code of the video analysis module 324.

The keyword generation module 325 may be implemented as instructions or program code for executing functions and/or operations for generating one or more keywords for search from the target scene, based on the metadata collected by the metadata collection module 323 and the scene information obtained by the video analysis module 324. According to one or more embodiments of the present disclosure, the keyword generation module 325 may generate one or more keywords by inputting the metadata and the scene information into a language model. For example, the keyword generation module 325 may input, to the language model, a prompt or query for outputting one or more keywords for search, together with the metadata and the scene information. The processor 310 may generate one or more keywords for searching for the content included in the target scene by executing the instructions or program code of the keyword generation module 325.

The search module 326 may be implemented as instructions or program code for executing functions and/or operations for performing a search based on one of the one or more keywords generated by the keyword generation module 325. According to one or more embodiments of the present disclosure, the search module 326 may be configured to select one keyword from the one or more keywords generated by the keyword generation module 325 and perform a search by using the selected keyword. The processor 310 may perform a search associated with the content of the target scene by executing the instructions or program code of the search module 326.

The communication interface 330 may perform wired or wireless communication with at least one external device. For example, the communication interface 330 may perform wired or wireless communication with the user controller 30. According to various embodiments of the disclosure, ‘communication’ may refer to an operation of transmitting and/or receiving data, a signal, a request, and/or a command.

The communication interface 330 may include at least one of a communication module, a communication circuit, a communication device, an input/output port, or an input/output plug for performing wired or wireless communication with the at least one external device. For example, the communication interface 330 may include a short-range communication module (e.g., an infrared (IR) communication module) capable of receiving a control command from a remote controller located in a short distance. The communication interface 330 may include at least one communication module that performs communication according to various wireless communication standards such as Bluetooth, Wi-Fi, Bluetooth Low Energy (BLE), Near Field Communication (NFC), Wi-Fi Direct, Ultra-wideband (UWB), or ZIGBEE. The communication interface 330 may further include a communication module for performing communication with a server for supporting long-distance communication according to a long-distance communication standard. For example, the communication interface 330 may include a communication module for performing communication via a network for Internet communication. The communication interface 330 may include a communication module that performs communication through a communication network following a 3^{rd} Generation Partnership Project (3GPP) communication standard, such as 5^{th} Generation (5G) or 6^{th} Generation (6G).

According to one or more embodiments of the present disclosure, the communication interface 330 may include at least one port for connection to an external device through a wired cable in order to communicate with the external device by wire. For example, the communication interface 330 may include at least one of various ports, such as a High-Definition Multimedia Interface (HDMI) port, a component jack, a DP PC port, a display port (DP), a digital visual interface (DVI) port, or a Universal Serial Bus (USB) port. According to various embodiments of the disclosure, a ‘port’ may refer to a physical component capable of connecting or inserting various connectors, such as a cable, a communication line, or a plug.

The display 340 may output image data and/or video data processed by the electronic device 100. In FIG. 3, the electronic device 100 is illustrated as including the display 340. However, the disclosure is not necessarily limited thereto. For example, the electronic device 100 may not include the display 340. Additionally or alternatively, the electronic device 100 may be connected wirelessly or by wire to an external display (e.g., an external TV, a monitor, a laptop, or a smartphone) via the communication interface 330. The electronic device 100 may provide an image and/or a video data to a user by transmitting image data and/or video data to the external display through the communication interface 330.

The display 340 may display video from various sources. For example, the display 340 may display at least one of a video stored in the memory 320 under a control by the processor 310, a video obtained from one or more applications executed by the processor 310, one or more UI elements to be provided to the user under a control by the processor 310, or a video received from an external device through the communication interface 330.

According to one or more embodiments of the present disclosure, the display 340 may display the keyword search UI 210 for providing a response to the content search request from the user. The keyword search UI 210 displayed on the display 340 may include at least one UI element (e.g., the scene selection UI element 211, the still cut UI element 212, the keyword list UI element 213, or the search result UI element 214). In response to an input from the user, the at least one UI element displayed on the display 340 may be modified. For example, in response to an input regarding a change in the target scene from the user, the still cut UI element 212 displayed on the display 340 may be modified. The still cut UI element 212 may be modified to indicate (or represent) a changed target scene indicated by the user. In response to an input regarding a keyword change from the user, the keyword list UI element 213 and/or the search result UI element 214 displayed on the display 340 may be modified. For example, the keyword list UI element 213 may be modified to indicate (or represent) a changed keyword indicated by the user. The search result UI element 214 may be modified to represent a result of a search performed based on the changed keyword. Although FIG. 3 illustrates the display 340 as being included within the electronic device 100, the embodiments of the present disclosure are not limited to this configuration. The display 340 may instead be an external display device located outside the electronic device 100, with the electronic device 100 transmitting a control signal to display the keyword search UI 210 on the external display.

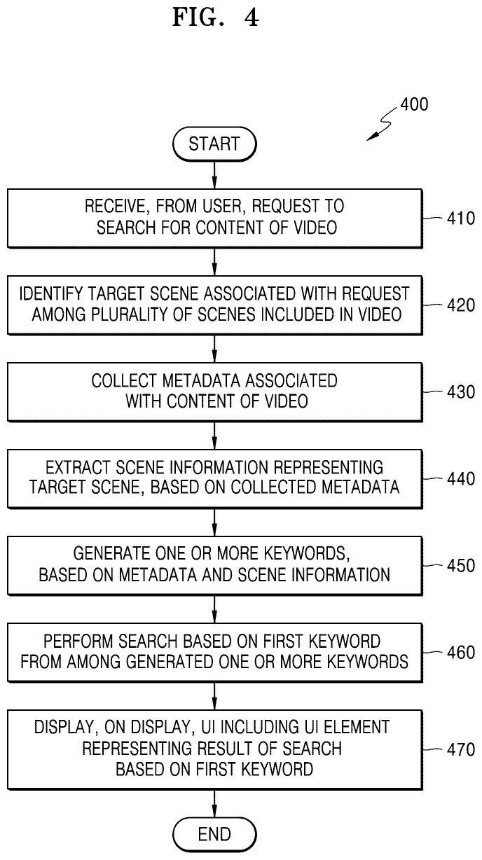

FIG. 4 is a flowchart of a method 400 performed by the electronic device 100, according to one or more embodiments of the present disclosure.

Referring to FIG. 4, the method 400 of FIG. 4 may be performed by the electronic device 100 of FIG. 1. The method 400 may include operations 410, 420, 430, 440, 450, 460, and 470. However, the disclosure is not limited thereto, and operations 410, 420, 430, 440, 450, 460, and 470 may be performed individually or collectively (e.g., in parallel) by one or more electronic devices. A method according to one or more embodiments of the present disclosure is not limited to that shown in FIG. 4. Any one of the operations shown in FIG. 4 may be omitted, or the method according to one or more embodiments of the present disclosure may further include operations not shown in FIG. 4. According to the disclosure, the order of at least some of the operations 410, 420, 430, 440, 450, 460, and 470 may be changed.

In operation 410, the electronic device 100 may receive, from a user, a request to search for the content of a video. For example, the electronic device 100 may receive, from the user via a UI, a request to search for the content of the video. The electronic device 100 may receive, from the user via the communication interface 330, a request to search for the content of the video.

In operation 420, the electronic device 100 may identify a target scene associated with the request among a plurality of scenes included in the video. According to one or more embodiments of the present disclosure, the electronic device 100 may store a copy of at least a portion of the video. The electronic device 100 may extract one or more still cuts from the stored copy. The electronic device 100 may display, on the display 340, a UI element (e.g., the still cut UI element 212) representing at least some of the one or more still cuts and/or a UI element (e.g., the selection UI element 211) representing a request for selecting a target scene from among one or more still cuts. The electronic device 100 may obtain, from the user, an input of selecting a first still cut from among the one or more still cuts. In response to the input, the electronic device 100 may identify, as the target scene, a scene corresponding to the first still cut from among the one or more still cuts.

According to one or more embodiments of the present disclosure, the electronic device 100 may identify the scene displayed on the display 340 as the target scene at a time point when the request for searching for the content of the video is received. For example, the electronic device 100 may identify a scene corresponding to a frame displayed on the display 340 (e.g., a scene including the frame or a scene associated with the frame) as the target scene at a time point when the request for searching for the content of the video is received.

According to one or more embodiments of the present disclosure, the request for searching for the content of the video, which is received by the electronic device 100 from the user controller 30, may include information indicating a point in time when the request for searching for the content of the video is received from the user by the user controller 30. Based on the information included in the request, the electronic device 100 may identify the scene displayed on the display 340 as the target scene at the time point when the request for searching for the content of the video is received from the user by the user controller 30. For example, the electronic device 100 may identify the scene corresponding to a frame displayed on the display 340 (e.g., the scene including the frame or the scene associated with the frame) as the target scene at a time point when the request for searching for the content of the video is received from the user by the user controller 30.

In operation 430, the electronic device 100 may collect metadata associated with the video. According to one or more embodiments of the present disclosure, the electronic device 100 may analyze an electronic program guide (EPG) associated with the video. Additionally or alternatively, the electronic device 100 may analyze one or more overlay elements included in the content of the video from the target scene, and collect information about the video, based on the analyzed overlay elements. Additionally or alternatively, the electronic device 100 may perform an additional search for the video.

In operation 440, the electronic device 100 may extract scene information representing the target scene, based on the collected metadata. According to one or more embodiments of the present disclosure, the electronic device 100 may input the target scene to a vision-language model (VLM). The electronic device 100 may obtain scene description information describing the target scene from the VLM. Additionally or alternatively, the electronic device 100 may perform automatic speech recognition (ASR) with respect to a specific time section of the video including the target scene. Based on execution of ASR, the electronic device 100 may obtain text data corresponding to voice data (or showing voice) included in the specific time section. Additionally or alternatively, the electronic device 100 may detect one or more objects from the target scene. Based on a result of the detection, the electronic device 100 may obtain a list of the one or more objects included in the target scene. Additionally or alternatively, the electronic device 100 may recognize one or more faces included in the target scene, based on the metadata. Based on the recognized one or more faces, the electronic device 100 may obtain information of the one or more faces appearing on the target scene.

In operation 450, the electronic device 100 may generate the one or more keywords, based on the metadata collected in operation 430 and the scene information extracted in operation 440. According to one or more embodiments of the present disclosure, the electronic device 100 may input the metadata and the scene information to the language model. The electronic device 100 may obtain the one or more keywords from the language model. For example, the electronic device 100 may use a language model of generating an output in a natural language form, such as a VLM or a large language model (LLM). Additionally or alternatively, the electronic device 100 may transmit at least some of the generated one or more keywords to a user terminal (e.g., the user controller 30) of the user.

In operation 460, the electronic device 100 may perform search based on a first keyword from among the generated one or more keywords. In operation 470, the electronic device 100 may display, on a display, a UI (e.g., the keyword search UI 210) including a UI element (e.g., the search result UI element 214) representing a result of the search based on the first keyword. Additionally or alternatively, the electronic device 100 may display, on the display 340, a UI element representing the one or more keywords (e.g., the keyword list UI element 213). Additionally or alternatively, the electronic device 100 may display, on the display 340, a UI element representing a request for selecting one keyword from among the one or more keywords. The electronic device 100 may obtain, from the user, an input for selecting a second keyword from among the one or more keywords. In response to the input, the electronic device 100 may perform a search based on the second keyword. The electronic device 100 may display, on the display 340, a UI element representing a result of the search based on the second keyword. According to one or more embodiments of the present disclosure, the electronic device 100 may correct the UI element representing the result of the search based on the first keyword, so that the UI element represents the result of the search based on the second keyword.

A computer-readable recording medium according to one or more embodiments of the present disclosure may store a program for at least partially performing the operations included in the above-described method 400 on a computer. For example, the computer-readable recording medium may store a program for performing one or more combinations of the operations described herein on a computer.

The instructions stored in the memory 320 of FIG. 3, when being individually or collectively executed by the processor 310 of FIG. 3, may cause the electronic device 100 to at least partially perform the operations included in the above-described method 400. For example, the instructions stored in the memory 320 of FIG. 3, when being individually or collectively executed by the processor 310 of FIG. 3, may cause the electronic device 100 to perform one or more combinations of the operations described above in the disclosure.

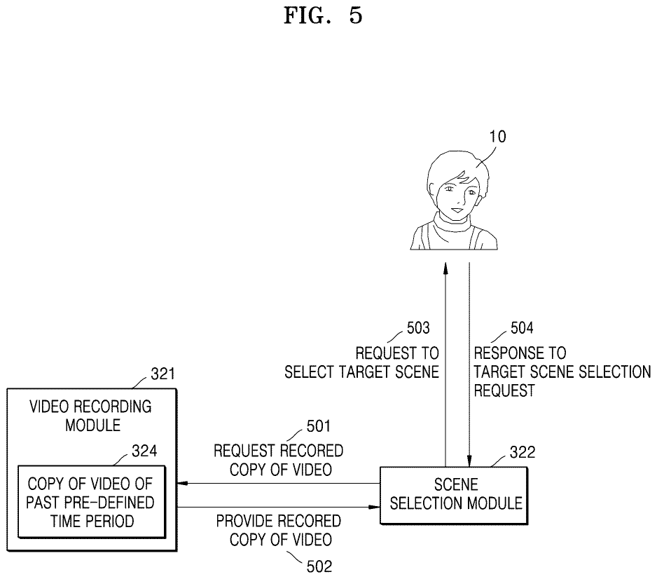

FIG. 5 illustrates exemplary operations for selecting a target scene, according to one or more embodiments of the present disclosure.

Referring to FIG. 5, in response to a content search request from the user 10, the processor 310 may execute the scene selection module 322. The scene selection module 322 may obtain the content search request from the user 10. The scene selection module 322 may request a copy of the video recorded by the video recording module 321 (operation 501). The video recording module 321 may provide the recorded copy to the scene selection module 322 (operation 502).

The video recording module 321 may store at least a partial copy of a video played back by the electronic device 100 (e.g., a video displayed through the display 340 of the electronic device 100). According to one or more embodiments of the present disclosure, the video recording module 321 may store a copy of a predefined length. The video recording module 321 may store only a predefined number of past frames among most recently played-back frames. For example, the video recording module 321 may store a copy of a video of a 10-second length. In response to a request from the scene selection module 322, in operation 502, the video recording module 321 may provide the video copy stored in the scene selection module 322.

The scene selection module 322 may extract one or more still cuts from the video copy. According to one or more embodiments of the present disclosure, the scene selection module 322 may extract one or more still cuts by sampling the video copy at predefined time intervals. For example, the scene selection module 322 may extract one or more still cuts by capturing frames included in the video copy at predefined time intervals.

The scene selection module 322 may request the user 10 to select a target scene (operation 503). For example, the scene selection module 322 may request the user 10 to select a still cut corresponding to the target scene from among the one or more still cuts. According to one or more embodiments of the present disclosure, to request the user 10 to select the target scene for performing a content search, the scene selection module 322 may display a UI element representing the one or more still cuts on the display 340. Additionally or alternatively, the scene selection module 322 may display, on the display 340, a UI element representing text for requesting the user 10 to select the target scene for performing a content search. The scene selection module 322 may receive a response to the target scene selection request from the user 10 (operation 504). The scene selection module 322 may identify, as the target scene, a scene corresponding to the still cut selected by the user 10.

According to one or more embodiments of the present disclosure, the scene selection module 322 may automatically identify a scene corresponding to a frame displayed on the display 340 as the target scene at a time point when a content search request is obtained from the user 10. For example, in response to the content search request from the user 10, the scene selection module 322 may automatically identify the target scene, generate one or more keywords from the automatically identified target scene, perform a search based on one of the generated one or more keywords, and provide a result of the search to the user 10. The scene selection module 322 may display, on the display 340, a UI element for providing a target scene change function to the user 10, together with a UI element representing a search result. In response to a target scene change request from the user 10, the scene selection module 322 may identify a new target scene and provide a search results based on the new target scene.

According to one or more embodiments of the present disclosure, the content search request from the user 10 may be provided via the user controller 30. The content search request from the user 10 provided by the user controller 30 may include a timestamp indicating a time point when the user controller 30 has received the content search request from the user 10. Based on the timestamp included in the content search request from the user 10, the scene selection module 322 may identify a scene corresponding to a frame displayed on the display 340 as the target scene at the time point when the content search request has received from the user 10.

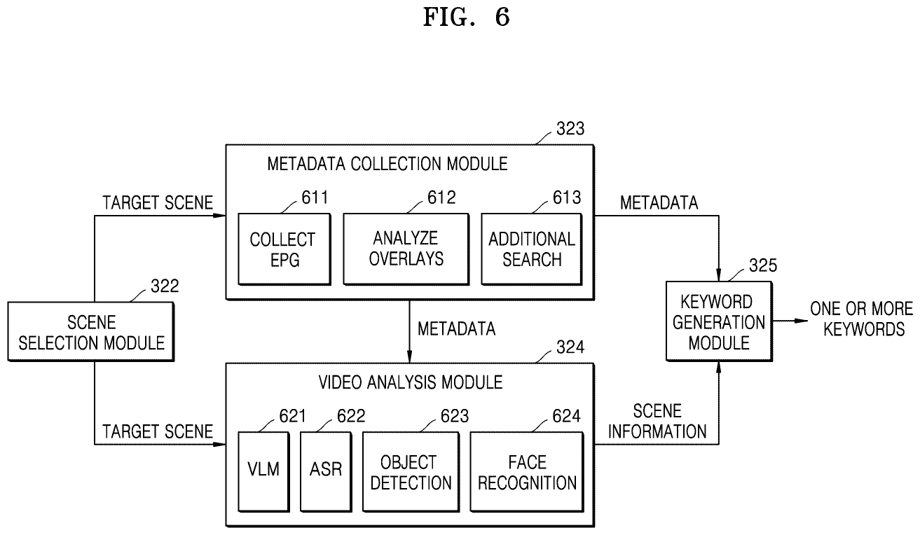

FIG. 6 is a block diagram illustrating exemplary operations for collecting metadata and exemplary operations for obtaining scene information, according to one or more embodiments of the present disclosure.

Referring to FIG. 6, the scene selection module 322 may provide the identified target scene to the metadata collection module 323 and the video analysis module 324. The metadata collection module 323 may collect information about a video currently being played back on the display 340, the video including the target scene.

According to one or more embodiments of the present disclosure, the metadata collection module 323 may obtain an EPG associated with the video and collect information related to the video from the obtained EPG (operation 611). According to one or more embodiments of the present disclosure, the EPG may be a digital guide that provides information about a program associated with the video. For example, the EPG may include various pieces of information about a program including the video, such as a broadcast channel on which the video was broadcast (or a platform on which the video was released), the title of the program including the video, a broadcast (or release) schedule of the video, a brief description or summary of the program including the video, the genre of the video, information about the characters and cast of the video, information about the producers and distributors of the video, the regional information of the video, such as the language of the audio and subtitles included in the video, keywords or tags predefined (e.g., by a distributor, a producer, and/or a platform) for the video, and/or series information (such as, a season and episode number corresponding to the video).

According to one or more embodiments of the present disclosure, the metadata collection module 323 may analyze one or more overlays included in the video (operation 612). According to the disclosure, ‘overlay’ may refer to a graphic element or text element additionally displayed over the original video. For example, the video may include various text, graphic, or image overlays, such as a subtitle, a program logo, a timestamp, an advertising logo or message, a program title, an episode number, an age restriction instruction, a warning message, an image quality indication, an audio option indication, or a sponsor logo. The metadata collection module 323 may obtain various pieces of information about the target scene by analyzing the one or more overlays included in the video. For example, the metadata collection module 323 may obtain, from the one or more overlays, information for identifying the source or production company of the program, the type or genre of the program, the language of the program, information related to the broadcast time of the program, a target audience of the program, sensitivity of the program (e.g., violence or obscenity), the image quality of the video, and information about tags or keywords added in advance to the video.

According to one or more embodiments of the present disclosure, the metadata collection module 323 may perform an additional search regarding the video (operation 613). The metadata collection module 323 may search for the file name of the video recorded in the memory 320 by using a search engine. The metadata collection module 323 may obtain information about the video from an application associated with the playback of the video, and search for one or more elements included in the obtained information by using the search engine. The metadata collection module 323 may perform a search for the one or more elements included in the information collected from the EPG and/or the information collected via the overlay analysis, by using the search engine. For example, the metadata collection module 323 may perform an additional search for the photos of cast members, based on cast information collected from the EPG.

The video analysis module 324 may extract scene information describing the target scene from the target scene, based on the target scene and the metadata. The video analysis module 324 may extract scene description information regarding the target scene, by using a VLM (operation 621). For example, the VLM may refer to a language model trained (e.g., pre-trained) to receive image data and generate a natural language description of the image data. For example, the VLM may be an image captioning model that generates descriptive sentences regarding a received image. The video analysis module 324 may input the target scene to the VLM. The VLM may generate a natural language output that describes the target scene.

The video analysis module 324 may perform ASR with respect to the target scene (operation 622). The video analysis module 324 may convert an audio signal included in the target scene (or a set of frames including a frame of the target scene) into text. For example, the video analysis module 324 may perform speech recognition on a set of a frame corresponding to the target scene and a predefined number of frames before and after the frame. By performing ASR on the target scene, the video analysis module 324 may extract a dialogue included in the target scene, in a text form. According to one or more embodiments of the present disclosure, the video analysis module 324 may perform ASR by using at least one of various artificial intelligence models, such as a Hidden Markov Model (HMM), a Gaussian Mixture Model (GMM), a DNN, an RNN, a CNN, or a language model (e.g., transformers).

According to one or more embodiments of the present disclosure, the video analysis module 324 may perform ASR by using a language model that receives an audio input. For example, the video analysis module 324 may extract an audio signal corresponding to the target scene, and input the extracted audio signal to the language model. The language model may convert a dialog included in the audio signal into text. According to one or more embodiments of the present disclosure, the language model may generate a natural language output that represents or indicates sounds included in the audio signal (e.g., a soundtrack, background noise, or sound effects).

The video analysis module 324 may perform object detection with respect to the target scene (operation 623). For example, the video analysis module 324 may recognize and classify one or more objects included in the target scene. Accordingly, the video analysis module 324 may obtain a list of the objects included in the target scene. According to one or more embodiments of the present disclosure, the video analysis module 324 may identify the one or more objects included in the target scene by using at least one of various object detection algorithms, such as a Region-based CNN (R-CNN) based algorithm, a You Only Look Once (YOLO), or a Single Shot Detector (SSD).

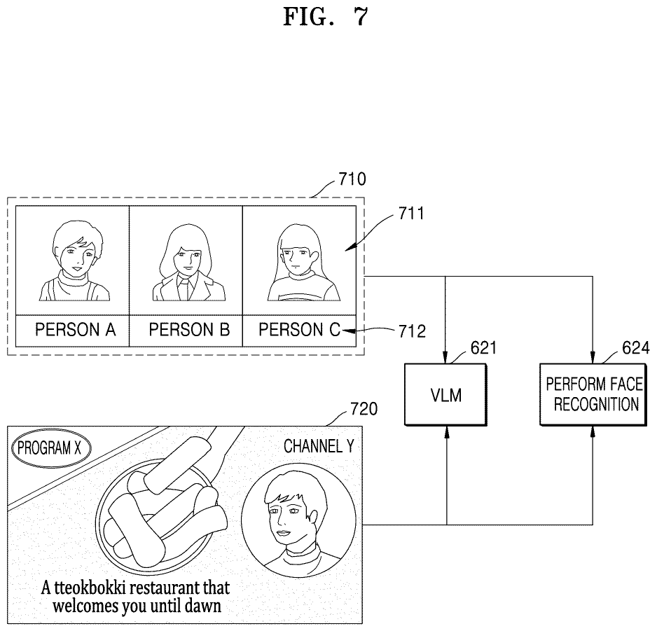

The video analysis module 324 may perform face recognition with respect to the target scene (operation 624). For example, the video analysis module 324 may detect one or more human faces included in the target scene, and may identify the detected human faces. According to one or more embodiments of the present disclosure, the video analysis module 324 may recognize one or more faces included in the target scene by using an artificial intelligence model based on a neural network such as a CNN. According to one or more embodiments of the present disclosure, the video analysis module 324 may perform face recognition by using cast information included in the metadata, as in the embodiment of FIG. 7.

Table 1 exemplarily represents various pieces of information included in scene information obtained by the video analysis module 324 according to one or more embodiments of the present disclosure.

TABLE 1

| Information type | Example |
|---|---|
| Scene description | This image appears to be a close-up of tteokbokki from a TV |
| information obtained | program. This image shows a moment when rice cakes are |
| using VLM | scooped with a ladle from a pot of boiling tteokbokki broth, the |
| | broth being filled with a thick, spicy red sauce. The rice cakes |
| | in tteokbokki are seen smooth, shiny, and look deliciously |
| | cooked. |
| | In a lower portion of the screen, there is a caption that says, |
| | “A tteokbokki restaurant that welcomes you until dawn,” |
| | emphasizing that this tteokbokki restaurant is open until late |
| | at night. |
| | In addition, a man's face is faintly superimposed on a right |
| | lower portion of the screen, and this man appears to be a |
| | guest on a show introducing a tteokbokki restaurant. This |
| | scene seems to be a moment that conveys the taste and |
| | popularity of tteokbokki to viewers and focuses on the charm |
| | of the tteokbokki restaurant. |
| Dialog information | It's ramyeon with rice cake in it. |
| obtained via ASR | If you put ramyeon in here, I won't stay still. |
| | Yeah, I can't stand that. |
| | That . . . . I don't do that kind of thing. |
| | This is the tteokbokki restaurant I've been going to most often |
| | recently. |
| List of objects obtained | Human face, tteokbokki |
| through object detection | |
| Characters obtained | Person B |
| through face recognition | |

According to one or more embodiments of the present disclosure, a VLM, an algorithm for ASR, an algorithm for object detection, and an algorithm for face recognition may be stored in the memory 320 of the electronic device 100. According to one or more embodiments of the present disclosure, at least one of the VLM, the algorithm for ASR, the algorithm for object detection, or the algorithm for face recognition may be stored in an external device, and the electronic device 100 may access the VLM, the algorithm for ASR, the algorithm for object detection, and/or the algorithm for face recognition stored in the external device.

FIG. 7 illustrates an exemplary operation for obtaining scene information, according to one or more embodiments of the present disclosure.

Referring to FIG. 7, the video analysis module 324 may obtain scene information by using cast information and cast photos included in metadata. For example, the video analysis module 324 may use information 710 about characters included in the metadata and a target scene 720 (or one frame of a target scene including a plurality of frames) to obtain scene description information about the target scene 720 and/or perform face recognition on the target scene 720. The information 710 may include a photo or image(s) 711 of each character and a name(s) 712 of a corresponding actor. For example, in the embodiment illustrated in FIG. 7, the information 710 may include a photo of each person along with the names of person A, person B, and person C, in the form of a table.

The video analysis module 324 may input, to the VLM, a prompt for requesting description of the target scene 720 based on the information 710 along with the information 710 and the target scene 720 (operation 621). For example, the video analysis module 324 may input, to the VLM, a prompt such as “Describe the target scene by using given cast information”. Accordingly, scene description information including a description such as “There is a photo of person A in a right lower portion of the screen” may be obtained from the VLM. According to one or more embodiments of the present disclosure, the video analysis module 324 may synthesize the information 710 and the target scene 720 into a single image. The video analysis module 324 may input, to the VLM, a prompt such as “Describe the scene in a lower portion of an image, based on the cast photos and names listed in an upper portion of the image” along with the synthesized image. Accordingly, the accuracy of the scene description information may be improved.

The video analysis module 324 may input the information 710 and the target scene 720 with respect to a face recognition algorithm. Accordingly, the face recognition algorithm may match faces included in the target scene 720 with people included in the information 710. Accordingly, the accuracy of face recognition may be improved.

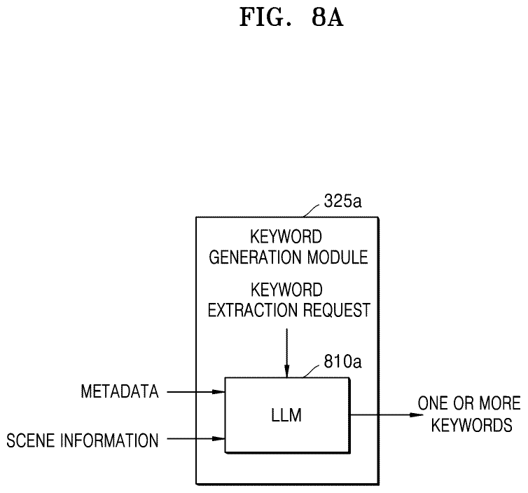

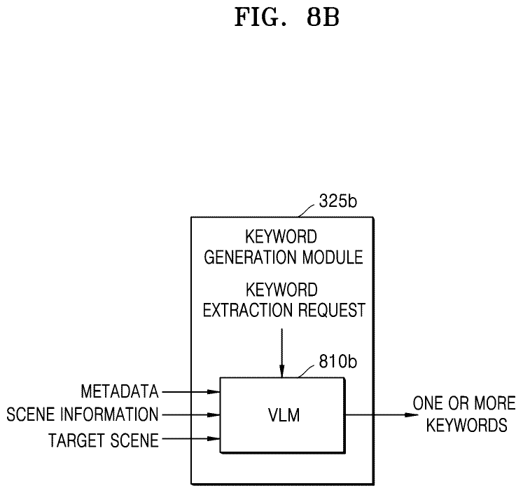

FIGS. 8A and 8B are block diagrams illustrating an operation of generating one or more keywords, according to one or more embodiments of the present disclosure.

Referring to FIGS. 8A and 8B, the keyword generation module 325 of FIG. 3 may generate one or more keywords by using a language model. For example, a keyword generation module 325a of FIG. 8A may generate the one or more keywords by using an LLM 810a. The keyword generation module 325a may input the metadata obtained by the metadata collection module 323 and the scene information obtained by the video analysis module 324 to the LLM 810a. The keyword generation module 325a may input a prompt including a keyword extraction request to the LLM 810a. For example, the keyword generation module 325a may input, to the LLM 810a, a prompt including a query for an expected query word, such as “What can viewers search for, under given information?”. In response to the prompt, based on the scene information and the metadata information, the LLM 810a may infer one or more expected query words or query keywords and output a result of the inference in a natural language form.

A keyword generation module 325b of FIG. 8B may generate one or more keywords by using an LLM 810b. The keyword generation module 325b may input the metadata obtained by the metadata collection module 323, the scene information obtained by the video analysis module 324, and the target scene to a VLM 810b. The keyword generation module 325b may input a prompt including a keyword extraction request to the VLM 810b. For example, the keyword generation module 325b may input, to the VLM 810b, a prompt including a query for an expected query word, such as “What can viewers search for with respect to the target scene, under given information?”. In response to the prompt, based on the scene information and the metadata information, the VLM 810b may infer one or more expected query words or query keywords and output a result of the inference in a natural language form.

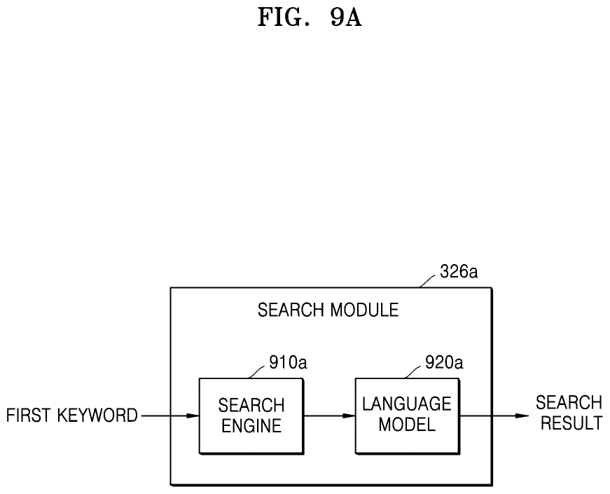

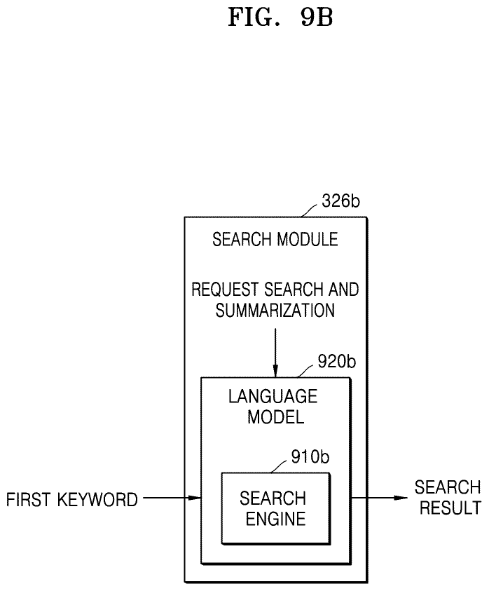

FIGS. 9A and 9B are block diagrams illustrating an operation of performing a search based on a first keyword, according to one or more embodiments of the present disclosure.

Referring to FIGS. 9A and 9B, the search module 326 of FIG. 3 may select one keyword from the one or more keywords generated by the keyword generation module 325 and perform a search by using the selected keyword. The search module 326 may obtain a list of the generated one or more keywords from the LLM 810a or the VLM 810b, and may select one keyword according to a predefined rule or randomly. For example, the search module 326 may select the keyword at the top of the keyword list. In the embodiments of FIGS. 9A and 9B, it is assumed that a search module 326a or 326b has selected a first keyword among one or more keywords.

The search module 326a of FIG. 9A may perform a search by using a search engine 910a. The search module 326a may input the first keyword as a search query to the search engine 910a. In response to the first keyword, the search engine 910a may output search results in various forms, such as one or more web documents, news, web page links, or images. The search module 326a may input an output of the search engine 910a based on the first keyword to a language model 920a. The search module 326a may input, to the language model 920a, a prompt requesting summarization of the output of the search engine 910a based on the first keyword. For example, the search module 326a may input, to the language model 920a, a prompt such as “Summarize a result best conforming to the first keyword among the search results.” Accordingly, the language model 920a may infer a summary of the output of the search engine 910a, and generate a result of the inference in a natural language form.

A search module 326b of FIG. 9B may perform a search by using a language model 920b including a search engine 910b. The search module 326b may input, to the language model 920b, a prompt of requesting execution of a search based on the first keyword and summarization of a result of the search. For example, the search module 326b may input, to the language model 920b, a prompt such as “Search for a first keyword and summarize a result suitable for the first keyword among the search results.” Accordingly, the language model 920b may perform a search for the first keyword by using the search engine 910b, infer a summary of the output of the search engine 910b, and generate a result of the inference in a natural language form.

According to one or more embodiments of the present disclosure, the search engine 910a, the language model 920a, and the language model 920b may be stored in the memory 320 of the electronic device 100. According to one or more embodiments of the present disclosure, the search engine 910a, the language model 920a, and the language model 920b may be stored in an external device, and the electronic device 100 may access the search engine 910a, the language model 920a, and the language model 920b through the external device.

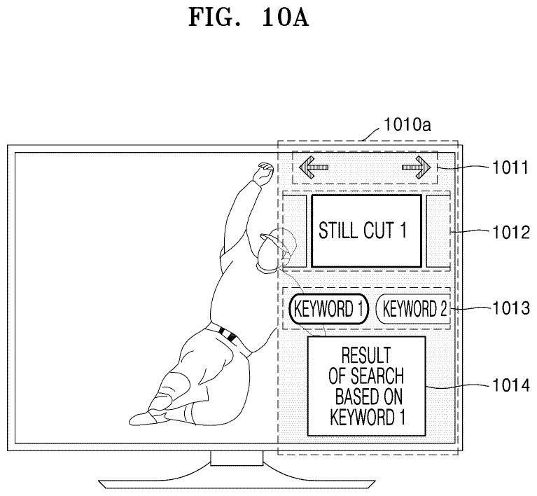

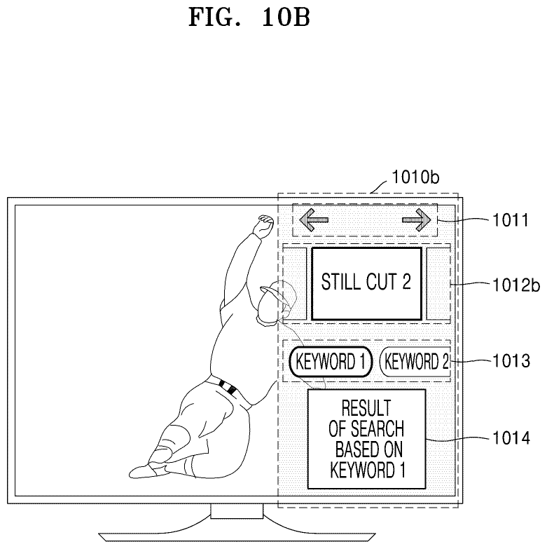

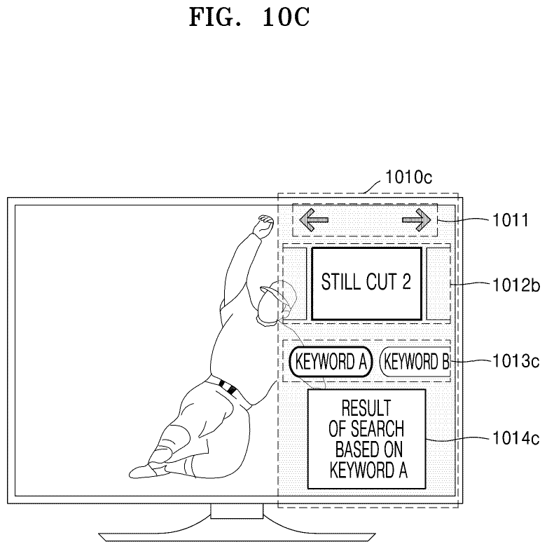

FIGS. 10A through 10C illustrate exemplary UIs (e.g., 1010a, 1010b, and 1010c) that may be displayed by an electronic device, according to one or more embodiments of the present disclosure.

Referring to FIG. 10A, in response to receiving a content search request from a user, the electronic device 100 may automatically identify a scene corresponding to ‘still cut 1’ as a target scene. The electronic device 100 may generate one or more keywords from the target scene, and may perform search, based on ‘keyword 1’ from among the generated one or more keywords. In response to the user's content search request, the electronic device 100 may provide a content search request result based on keyword 1 by displaying a keyword search UI 1010a on the display 340.

The keyword search UI 1010a may include at least one of a scene selection UI element 1011, a still cut UI element 1012, a keyword list UI element 1013, or a search result UI element 1014. The scene selection UI element 1011, the still cut UI element 1012, the keyword list UI element 1013, and the search result UI element 1014 may be respectively configured in similar methods to those in which the scene selection UI element 211, the still cut UI element 212, the keyword list UI element 213, and the search result UI element 214 of FIG. 2 are configured.

In the embodiment of FIG. 10A, the scene selection UI element 1011 may include one or more icons for requesting the user 10 to (re)select the target scene. The still cut UI element 1012 may represent (or include) one or more still cuts extracted from a video. For example, the still cut UI element 1012 may at least partially represent at least some of the one or more still cuts including ‘still cut 1’. The still cut UI element 1012 may include a UI element (e.g., a bold border) for highlighting ‘still cut 1’ corresponding to the target scene. The keyword list UI element 1013 may at least partially represent a list of the one or more keywords generated from the target scene. The keyword list UI element 1013 may include ‘keyword 1’ and a portion of ‘keyword 2’. The search result UI element 1014 may represent a result of a search based on a keyword currently selected by the electronic device 100 (e.g., a first keyword).

In the embodiment of FIG. 10B, the electronic device 100 may receive, from the user, a request for switching a selected still cut. For example, the electronic device 100 may receive, from the user, a request for switching a selected still cut from among the still cuts shown in the still cut UI element 1012 from ‘still cut 1’ to ‘still cut 2’. The electronic device 100 may notify the user that the selected still cut has been switched, by displaying a keyword search UI 1010b on the display 340. The keyword search UI 1010b may include a still cut UI element 1012b instead of the still cut UI element 1012 of FIG. 10A. The still cut UI element 1012b may include a UI element (e.g., a bold border) for highlighting that a currently selected still cut is ‘still cut 2’. According to one or more embodiments of the present disclosure, the electronic device 300 may modify the still cut UI element 1012 displayed on the display 340 such that ‘still cut 2’ is positioned at the center of the still cut UI element 1012, as in the still cut UI element 1012b.

In the embodiment of FIG. 10C, the electronic device 100 may receive, from the user, a request for switching the target scene. For example, the electronic device 100 may receive, from the user, an input of indicating ‘still cut 2’ as the target scene. Accordingly, the electronic device 100 may re-generate one or more keywords from the target scene corresponding to ‘still cut 2’, and may perform search, based on ‘keyword A’ from among the re-generated one or more keywords. To provide a new search result, the electronic device 100 may display a keyword search UI 1010c on the display 340. Additionally or alternatively, the electronic device 100 may modify the keyword search UI 1010b displayed on the display 340 to be the keyword search UI 1010c.

The keyword search UI 1010c may include at least one of the scene selection UI element 1011 of FIG. 10A, the still cut UI element 1012b of FIG. 10B, a keyword list UI element 1013, or a search result UI element 1014c. The keyword list UI element 1013c may at least partially include a list of the one or more keywords generated from the new target scene. The keyword list UI element 1013c may include ‘keyword A’ and a portion of ‘keyword B’. The search result UI element 1014c may include a result of a search based on a keyword currently selected by the electronic device 100, that is, ‘keyword A’. According to one or more embodiments of the present disclosure, the electronic device 100 may modify the search result UI element 1014 displayed on the display 340 such that the search result UI element 1014 represents a search result based on ‘keyword A’, as in the search result UI element 1014c.

According to the embodiment of FIG. 10A, the user may automatically receive a search result from the electronic device 100 with a single input for requesting a content search. The electronic device 100 may automatically identify the target scene in response to a request from the user, automatically generate one or more search keywords from the target scene, perform a search, and provide a search result to the user through the display 340. Accordingly, the user's video viewing experience may be improved.

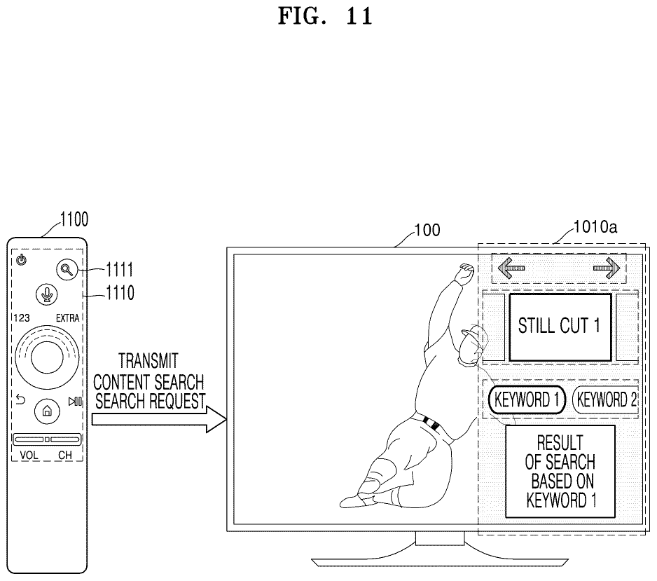

FIG. 11 illustrates an exemplary operation of receiving a content search request from a user via a remote controller 1100, according to one or more embodiments of the present disclosure.

Referring to FIG. 11, the remote controller 1100 may receive inputs for controlling the electronic device 100 from the user. In response to the user's inputs, the remote controller 1100 may transmit, to the electronic device 100, one or more control signals for controlling an operation of the electronic device 100. According to one or more embodiments of the present disclosure, the remote controller 1100 may communicate with the electronic device 100 by using IR signals.

The remote controller 1100 may include one or more physical buttons 1110 (or switches) through which the user can command any one of various operations of the electronic device 100. For example, the physical buttons 1110 may include various buttons, such as a button for turning on or off the electronic device 100, a button for activating a voice recognition function of the electronic device 100, a button for selecting one UI element from among the UI elements displayed by the electronic device 100, a button for controlling a sound volume of the electronic device 100, a button for controlling a broadcast channel displayed by the electronic device 100, a button for commanding the electronic device 100 to perform one function provided by the electronic device 100, or a button for commanding the electronic device 100 to execute one application provided by the electronic device 100. The shape and location of each button of the remote controller 1100 are not limited to the embodiment shown in FIG. 11.

The physical buttons 1110 may include a search button 1111 for instructing the electronic device 100 to search for content. The user may select the search button 1111 to search for the content of the video displayed by the electronic device 100. In response to an input for the search button 1111 from the user, the remote controller 1100 may transmit the content search request to the electronic device 100. For example, the content search request may correspond to a control signal for instructing execution of the content search request. In response to the content search request from the remote controller 1100, the electronic device 100 may identify the target scene, generate one or more keywords from the target scene, perform a search based on one of the generated one or more keywords, and display a result of the search on the display 340. For example, in response to the content search request from the remote controller 1100, the electronic device 100 may display the keyword search UI 1010a of FIG. 10A on the display 340.

According to one or more embodiments of the present disclosure, a request to search for the content of the video, which is transmitted by the remote controller 1100, may include information (e.g., a timestamp) indicating a time point when the user inputs the request for content search to the remote controller 1100. Based on the information indicating the time point at which the user inputs the request for content search to the remote controller 1100, the electronic device 100 may identify the target scene. For example, the electronic device 100 may identify a scene corresponding to a frame displayed on the display 340 as the target scene at the time point when the user inputs the request for content search to the remote controller 1100.

With one input for the search button 1111 of FIG. 11, the user may automatically receive a search result from the electronic device 100. The electronic device 100 may automatically identify the target scene in response to a request from the user, automatically generate one or more search keywords from the target scene, perform a search, and provide a search result to the user through the display 340. Accordingly, the user's video viewing experience may be improved.

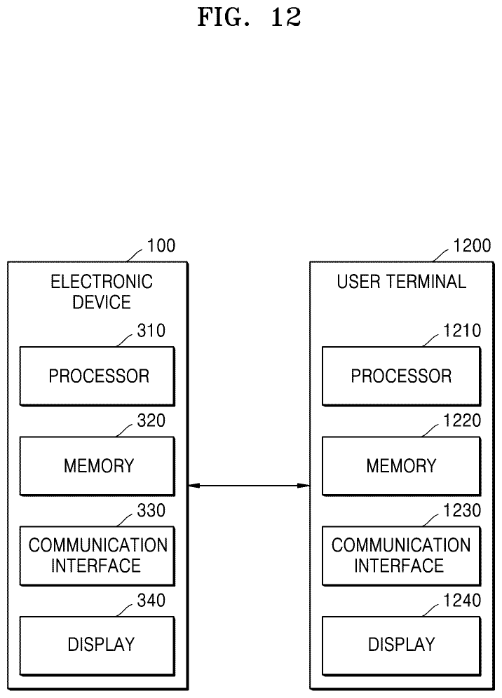

FIG. 12 is a block diagram of a user terminal 1200 communicating with the electronic device 100 according to one or more embodiments of the present disclosure.

Referring to FIG. 12, the electronic device 100 may communicate with the user terminal 1200 via a wire or wireless communication protocol. The electronic device 100 may include the processor 310 of FIG. 3, the memory 320 of FIG. 3, the communication interface 330 of FIG. 3, and the display 340 of FIG. 3. The user terminal 1200 may include a processor 1210, a memory 1220, a communication interface 1230, and a display 1240.

In FIG. 12, only essential components for describing the functions and/or operations of the user terminal 1200 are illustrated. The components included in the user terminal 1200 are not limited to those shown in FIG. 12. For example, one or more of the components illustrated in FIG. 12 may be deleted or changed, or the components not illustrated in FIG. 12 may be added to the user terminal 1200.

According to one or more embodiments of the present disclosure, the user terminal 1200 may be a portable device or a mobile device. In one or more embodiments of the present disclosure, the user terminal 1200 may further include a battery for supplying driving power to the processor 1210, the memory 1220, the display 1240, and the communication interface 1230.

The processor 1210 may execute one or more instructions of a program stored in the memory 1220. The processor 1210 may include hardware components that perform arithmetic, logic, and input/output operations. The processor 1210 is illustrated as a single element in FIG. 12, but embodiments of the disclosure are not limited thereto. According to one or more embodiments of the present disclosure, the processor 1210 may be configured with a plurality of elements.

The processor 1210 may include various processing circuitry and/or a plurality of processors. The processor 1210 may be implemented as, for example, a general-purpose processor (e.g., CPU), a graphics-only processor (e.g., GPU), or an artificial intelligence-only processor (e.g., TPU, NPU). The processor 1210 may control input data to be processed according to a predefined operation rule or artificial intelligence (AI) model. Alternatively, when the processor 1210 is an AI-only processor, the AI-only processor may be designed in a hardware structure specialized for processing a specific AI model.

The memory 1220 may store instructions, a data structure, and/or program code readable by the processor 1210. For example, the memory 1220 may store program code of an application for controlling the electronic device 100 that is readable (or executable) by the processor 1210. The memory 1220 may include one or more storage media of various forms, such as non-volatile memory and/or volatile memory.

The communication interface 1230 may perform data communication with other external devices (e.g., the electronic device 100) under a control by the processor 1210. According to one or more embodiments of the present disclosure, the communication interface 1230 may include a communication circuit(s) capable of performing data communication between the user terminal 1200 and the other electronic devices by using at least one of data communication methods including a wired local area network (LAN), a wireless LAN, Wi-Fi, Bluetooth, Zigbee, Wi-Fi Direct (WFD), infrared communication (e.g., infrared Data Association (IrDA)), Bluetooth Low Energy (BLE), Near Field Communication (NFC), Wireless Broadband Internet (WiBro), World Interoperability for Microwave Access (WiMAX), a shared wireless access protocol (SWAP), Wireless Gigabit Alliances (WiGig), and RF communication.

The display 1240 may output an image signal to the screen of the user terminal 1200 under the control by the processor 1210. For example, the display 1240 may output one or more UI elements for controlling an operation of the electronic device 100. According to one or more embodiments of the present disclosure, the display 1240 may include a touch panel. The touch panel may include one or more touch sensors that detect touch inputs. In response to a touch input from the user, one UI element may be selected from the one or more UI elements displayed on the display 1240.

According to one or more embodiments of the present disclosure, the user terminal 1200 may execute an application for transmitting, to the electronic device 100, a control signal for controlling an operation of the electronic device 100. For example, the user terminal 1200 may transmit, to the electronic device 100 via the application, various control signals, such as a control signal for turning on or off the electronic device 100, a control signal for activating a voice recognition function of the electronic device 100, a control signal for selecting one UI element from among the UI elements displayed by the electronic device 100, a control signal for controlling a sound volume of the electronic device 100, a control signal for controlling a broadcast channel displayed by the electronic device 100, a control signal for commanding the electronic device 100 to perform one function provided by the electronic device 100, or a control signal for commanding the electronic device 100 to execute one application provided by the electronic device 100.

According to one or more embodiments of the present disclosure, the user terminal 1200 may receive a list of one or more still cuts from the electronic device 100 via the communication interface 1230. For example, in response to the content search request, the electronic device 100 may extract one or more still cuts from a recent partial copy of the video stored in the video recording module 321, and provide the extracted still cuts to the user terminal 1200. The user terminal 1200 may perform at least some of the operations of the electronic device 100 described above with reference to FIGS. 5 through 9B. The user terminal 1200 may perform at least some of one or more operations of the scene selection module 322, the metadata collection module 323, the video analysis module 324, the keyword generation module 325, or the search module 326. For example, the user terminal 1200 may request the user to select the target scene for the one or more still cuts, collect metadata for the target scene selected by the user, obtain scene description information by analyzing the target scene based on at least a portion of the metadata, generate one or more keywords based on the metadata and the scene description information, and/or perform a search based on any one of the generated one or more keywords. The user terminal 1200 may provide a result of the search to the user via the display 1240.

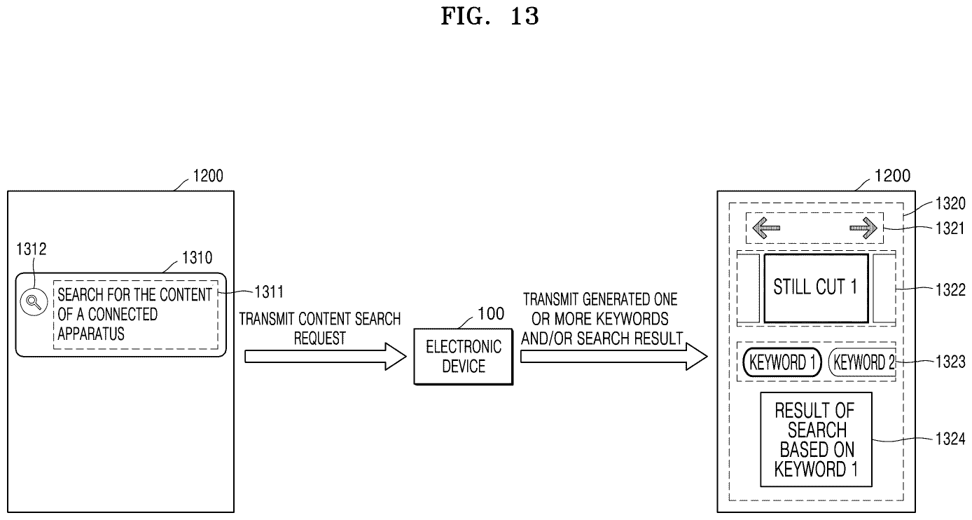

FIG. 13 illustrates exemplary UIs (e.g., 1310 and 1320) that may be displayed by the user terminal 1200, according to one or more embodiments of the present disclosure.

Referring to FIG. 13, the user terminal 1200 may execute an application for controlling an operation of the electronic device 100. Accordingly, one or more UIs (e.g., 1310 and 1320) for controlling the operation of the electronic device 100 may be displayed on the display 1240 of the user terminal 1200. According to one or more embodiments of the present disclosure, the user terminal 1200 may be any one of various terminals that may be operated by a user, such as a smartphone, a laptop, a PC, or a wearable device.

A control UI 1310 may include UI elements for controlling an operation of the electronic device 100. For example, the control UI 1310 may be a UI element for receiving, from the user, an indication of commanding the electronic device 100 to perform a video content function among the functions provided by the electronic device 100. The control UI 1310 may include text 1311 describing a function or operation of the electronic device 100 associated with the control UI 1310, such as “Search for the content of a connected apparatus,” and an icon 1312 describing a function or operation of the electronic device 100. However, the control UI 1310 may include only one of the text 1311 and the icon 1312, and a shape of the control UI 1310 is not limited to the embodiment of FIG. 13.

In response to receiving a user input for the control UI 1310 (e.g., a user's touch input for an area on the display 1240 where the control UI 1310 is displayed), the user terminal 1200 may request the electronic device 100 to perform a search for the content included in the video. For example, the user terminal 1200 may generate a control signal instructing the electronic device 100 to perform a content search, and may transmit the generated control signal to the electronic device 100 through the communication interface 1230. In response to the content search request from the user terminal 1200, the electronic device 100 may identify the target scene. The electronic device 100 may generate one or more keywords from the target scene. The electronic device 100 may perform search, based on at least one of the generated one or more keywords.

The electronic device 100 may transmit the generated one or more keywords and/or a result of the search to the user terminal 1200. The user terminal 1200 may display the received keywords and/or the received result of the search on the display 1240. For example, the user terminal 1200 may display, on the display 1240, a keyword search UI 1320 for providing the received keywords and/or the received result of the search. By displaying the keyword search UI 1320 on the display 1240, the user terminal 1200 may provide a content search result to the user of the user terminal 1200.

The keyword search UI 1320 may include at least one of a scene selection UI element 1321, a still cut UI element 1322, a keyword list UI element 1323, or a search result UI element 1324. According to one or more embodiments of the present disclosure, the electronic device 100 may automatically identify a scene corresponding to ‘still cut 1’ as the target scene in response to the content search result from the user terminal 1200, and may perform a search, based on the target scene. Accordingly, the scene selection UI element 1321, the still cut UI element 1322, the keyword list UI element 1323, and the search result UI element 1324 may be respectively configured in similar methods to those in which the scene selection UI element 1011, the still cut UI element 1012, the keyword list UI element 1013, and the search result UI element 1014 of FIG. 10 are configured.

According to one or more embodiments of the present disclosure, a request to search for the content of the video, which is transmitted by the user terminal 1200, may include information (e.g., a timestamp) indicating a time point when the user inputs the request for content search to the user terminal 1200. Based on the information indicating the time point at which the user inputs the request for content search to the user terminal 1200, the electronic device 100 may identify the target scene. For example, the electronic device 100 may identify a scene corresponding to a frame displayed on the display 340 as the target scene at the time point when the user inputs the request for content search to the user terminal 1200.

With one input for the search button 1310 of FIG. 13, the user may automatically receive a search result. The electronic device 100 may automatically identify the target scene in response to a request from the user, automatically generate one or more search keywords from the target scene, perform a search, and provide a search result and/or keywords to the user terminal 1200. The user terminal 1200 may provide a content search result to the user by displaying the keyword search UI 1320 on the display 1240. Accordingly, the user's video viewing experience may be improved.

According to one or more embodiments of the present disclosure, the electronic device 100 may be connected to a plurality of user terminals simultaneously. The electronic device 100 may receive a content search request from each of the plurality of user terminals. For each content search request, the electronic device 100 may automatically identify the target scene, automatically generate one or more search keywords from the target scene, perform a search, and provide a search result and/or keywords. Each user terminal may provide a corresponding search result to the user through a display built into each user terminal. A plurality of users may receive individual search results and/or keywords via their terminals, thereby obtaining desired search results without disturbing the viewing of other users.

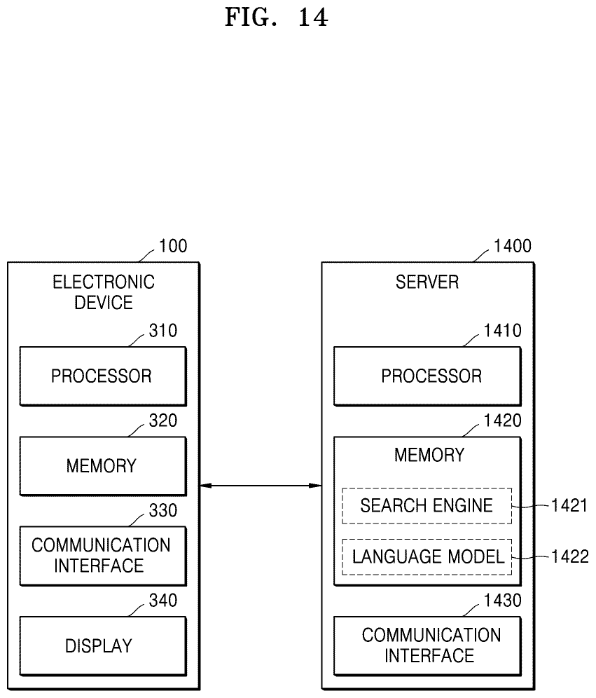

FIG. 14 is a block diagram of a server that communicates with an electronic device, according to one or more embodiments of the present disclosure.

Referring to FIG. 14, the electronic device 100 may communicate with a server 1400 via a wire or wireless communication protocol. The electronic device 100 may include the processor 310 of FIG. 3, the memory 320 of FIG. 3, the communication interface 330 of FIG. 3, and the display 340 of FIG. 3. The server 1400 may include a processor 1410, a memory 1420, and a communication interface 1430.

In FIG. 14, only essential components for describing the functions and/or operations of the server 1400 are illustrated. The components included in the server 1400 are not limited to those shown in FIG. 14. The configuration of the server 1400 illustrated in FIG. 14 is only an example, and examples of an electronic device that performs one or more embodiments of the present disclosure are not limited to the configuration illustrated in FIG. 14. According to one or more embodiments of the present disclosure, one or more of the components illustrated in FIG. 14 may be deleted or changed, or the components not illustrated in FIG. 14 may be added to the server 1400.

The processor 1410 may execute one or more instructions of a program stored in the memory 1420. The processor 1410 may include hardware components that perform arithmetic, logic, and input/output operations. The processor 1410 is illustrated as a single element in FIG. 14, but embodiments of the disclosure are not limited thereto. According to one or more embodiments of the present disclosure, the processor 1410 may be configured with a plurality of elements.

The processor 1410 may include various processing circuitry and/or a plurality of processors. The processor 1410 may be implemented as, for example, a general-purpose processor, a graphics-only processor, or an artificial intelligence-only processor. The processor 1410 may control input data to be processed according to a predefined operation rule or AI model. Alternatively, when the processor 1410 is an AI-only processor, the AI-only processor may be designed in a hardware structure specialized for processing a specific AI model.

The memory 1420 may store instructions, a data structure, and/or program code readable by the processor 1410. For example, the memory 1420 may store program code of an application for controlling the electronic device 100 that is readable (or executable) by the processor 1410. The memory 1420 may include one or more storage media of various forms, such as non-volatile memory and/or volatile memory.

According to one or more embodiments of the present disclosure, the memory 1420 may store instructions or program codes for distributing at least some of the operations or functions that may be performed by the electronic device 100 (e.g., the operations or functions described above as being performed by the video recording module 321, the scene selection module 322, the metadata collection module 323, the video analysis module 324, the keyword generation module 325, and the search module 326 of FIG. 3). For example, the memory 1420 may store program codes of a search engine 1421 and/or language model(s) 1422 executed or driven by the electronic device 100. The video analysis module 324 may request the server 1400 for description information about the target scene in order to perform scene analysis. The server 1400 may execute the language model 1422 to obtain scene description information for the target scene, and may provide the obtained scene description information to the video analysis module 324. The search module 326 may request the server 1400 for a search based on a selected keyword in order to perform search. The server 1400 may execute the search engine 1421 to provide an output of the search to the search module 326. The search module 326 may request the server 1400 for a summary of the search. The server 1400 may summarize the search result by using the language model 1422 and provide an output of the language model 1422 to the electronic device 100.

The communication interface 1430 may perform data communication with other external devices (e.g., the electronic device 100) under a control by the processor 1410. According to one or more embodiments of the present disclosure, the communication interface 1430 may include a communication circuit(s) capable of performing data communication between the server 1400 and the other electronic devices by using at least one of data communication methods including a wired local area network (LAN), a wireless LAN, Wi-Fi, Bluetooth, Zigbee, Wi-Fi Direct (WFD), infrared communication (e.g., infrared Data Association (IrDA)), Bluetooth Low Energy (BLE), Near Field Communication (NFC), Wireless Broadband Internet (WiBro), World Interoperability for Microwave Access (WiMAX), a shared wireless access protocol (SWAP), Wireless Gigabit Alliances (WiGig), and RF communication.

According to one or more embodiments of the present disclosure, a method performed by an electronic device may comprise receiving, from a user, a request to search for content of a video; identifying, among a plurality of scenes included in the video, a target scene associated with the request; collecting metadata associated with the video; extracting scene information representing the target scene based on the metadata; generating one or more keywords based on the metadata and the scene information; performing a search based on a first keyword among the one or more keywords; and controlling a display to display a keyword search user interface (UI), the keyword search UI including a search result UI element that represents a result of the search based on the first keyword.

Additionally or alternatively, the keyword search UI further includes a keyword list UI element representing the one or more keywords.

Additionally or alternatively, the method may further comprise obtaining, from the user, an input for selecting a second keyword among the one or more keywords; and modifying the search result UI element to represent an updated result of the search based on the second keyword.

Additionally or alternatively, the identifying the target scene may comprise: extracting one or more still cuts from a copy of at least a portion of the video; displaying, within the keyword search UI a still cut UI element representing the one or more still cuts and a selection UI element for selecting one still cut from among the one or more still cuts; obtaining, from the user, an input instructing to select a first still cut; and identifying a scene corresponding to the first still cut among the one or more still cuts as the target scene.

Additionally or alternatively, the identifying the target scene may comprise: extracting one or more still cuts from a copy of at least a portion of the video; transmitting the one or more still cuts to a user terminal; receiving, from the user terminal, selection of a second still cut among the one or more still cuts; and identifying the second still cut as the target scene.

Additionally or alternatively, the identifying the target scene may comprise identifying a scene displayed at a time point when the request for searching for the content of the video is received as the target scene.

Additionally or alternatively, the collecting the metadata may comprise: analyzing an electronic program guide (EPG) associated with the video; analyzing one or more overlays included in the content of the video from the target scene, collecting information about the video based on the one or more overlays; or performing a search for the content of the video.

Additionally or alternatively, the extracting the scene information may comprise: inputting the target scene to a vision-language model (VLM); and obtaining scene description information for the target scene from the VLM.

Additionally or alternatively, the extracting the scene information may comprise: performing automatic speech recognition (ASR) with respect to a first section of the video including the target scene; and obtaining text data corresponding to voice data included in the first section based on the performing the ASR.

Additionally or alternatively, the extracting the scene information may comprise: detecting one or more objects from the target scene; and obtaining a list of the one or more objects based on the detection of the one or more objects.

Additionally or alternatively, the extracting the scene information may comprise: recognizing one or more faces included in the target scene based on the metadata; and obtaining information about the one or more faces.

Additionally or alternatively, the generating the one or more keywords may comprise: inputting the metadata and the scene information to a language model; and obtaining the one or more keywords from the language model.

Additionally or alternatively, the method may further comprise transmitting at least one of the one or more keywords to a user terminal.

According to one or more embodiments of the present disclosure, a non-transitory computer-readable storage medium having stored thereon instructions that, when executed by a processor, cause the processor to: receive, from a user, a request to search for content of a video; identify, from among a plurality of scenes included in the video, a target scene associated with the request; collect metadata associated with the video; extract scene information representing the target scene based on the metadata; generate one or more keywords based on the metadata and the scene information; perform a search based on a first keyword among the one or more keywords; and control a display to display a keyword search user interface (UI), the keyword search UI comprising a search result UI element that represents a result of the search based on the first keyword.

According to one or more embodiments of the present disclosure, an electronic device may comprise: at least one processor including processing circuitry; memory including one or more storage media storing one or more instructions; a communication interface configured to perform communication with an external device; and a display configured to display a video. The one or more instructions, when executed by the at least one processor individually or collectively, cause the electronic device to: receive, from a user, a request to search for content of the video; identify, from among a plurality of scenes included in the video, a target scene associated with the request; collect metadata associated with the video; extract scene information representing the target scene based on the metadata; generate one or more keywords based on the metadata and the scene information; perform a search based on a first keyword among the one or more keywords; and control a display to display, a keyword search user interface (UI), the keyword search UI comprising a search result UI element that represents a result of the search based on the first keyword.

Additionally or alternatively, the one or more instructions, when executed by the at least one processor individually or collectively, may further cause the electronic device to: obtain, from the user, an input for selecting a second keyword among the one or more keywords; and modify the search result UI element to represent an updated result of the search based on the second keyword.

Additionally or alternatively, the one or more instructions, when executed by the at least one processor individually or collectively, may further cause the electronic device to: analyze an electronic program guide (EPG) associated with the video; analyze one or more overlays included in the content of the video from the target scene; based on the one or more overlays, collect information about the video; or perform a search for the content of the video.

Additionally or alternatively, the one or more instructions, when executed by the at least one processor individually or collectively, may further cause the electronic device to: obtain scene description information for the target scene by inputting the target scene to a vision-language model (VLM); obtain text data corresponding to voice data included in a first section of the video including the target scene based on performance of automatic speech recognition (ASR) with respect to the first section; detect one or more objects from the target scene; or recognize one or more faces included in the target scene based on the metadata.

Additionally or alternatively, the one or more instructions, when executed by the at least one processor individually or collectively, may further cause the electronic device to: input the metadata and the scene information to a language model; and obtain the one or more keywords from the language model.

Additionally or alternatively, the one or more instructions, when executed by the at least one processor individually or collectively, may further cause the electronic device to transmit at least one of the one or more keywords to a user terminal via the communication interface.

According to one or more embodiments of the present disclosure, to search for content currently being viewed through the electronic device 100, a viewer may request the electronic device 100 to perform a content search. In response to the request from the viewer, the electronic device 100 may analyze content currently being played back, generate one or more recommended keywords predicted to be searched by the viewer, perform a search based on any one of the recommended keywords, and provide a result of the search to the viewer. Accordingly, the viewer may obtain a content search result with minimal effort. The electronic device 100 may quickly provide the viewer with the search result the viewer wants, while minimizing disruption to viewing experience.

The machine-readable storage medium may be provided as a non-transitory storage medium. The ‘non-transitory storage medium’ is a tangible device and only means that it does not contain a signal (e.g., electromagnetic waves). This term does not distinguish a case in which data is stored semi-permanently in a storage medium from a case in which data is temporarily stored. For example, the non-transitory recording medium may include a buffer in which data is temporarily stored.

According to one or more embodiments of the present disclosure, methods according to various disclosed embodiments may be provided by being included in a computer program product. The computer program product, which is a commodity, may be traded between sellers and buyers. Computer program products are distributed in the form of device-readable storage media (e.g., compact disc read only memory (CD-ROM)), or may be distributed (e.g., downloaded or uploaded) through an application store or between two user devices (e.g., smartphones) directly and online. In the case of online distribution, at least a portion of the computer program product (e.g., a downloadable app) may be stored at least temporarily in a device-readable storage medium, such as a memory of a manufacturer's server, a server of an application store, or a relay server, or may be temporarily generated.

While the disclosure has been particularly shown and described with reference to examples thereof, it will be understood by those of ordinary skill in the art that various changes in form and details may be made therein without departing from the spirit and scope of the disclosure as defined by the following claims. For example, an appropriate result may be attained even when the above-described techniques are performed in a different order from the above-described method, and/or components, such as the above-described computer system or module, are coupled or combined in a different form from the above-described methods or substituted for or replaced by other components or equivalents thereof.

What is claimed is:

1. A method performed by an electronic device, the method comprising:
receiving, from a user, a request to search for content of a video;
identifying, among a plurality of scenes included in the video, a target scene associated with the request;
collecting metadata associated with the video;
extracting scene information representing the target scene based on the metadata;
generating one or more keywords based on the metadata and the scene information;
performing a search based on a first keyword among the one or more keywords; and
controlling a display to display a keyword search user interface (UI), the keyword search UI including a search result UI element that represents a result of the search based on the first keyword.

2. The method of claim 1, wherein the keyword search UI further includes a keyword list UI element representing the one or more keywords.

3. The method of claim 1, further comprising:
obtaining, from the user, an input for selecting a second keyword among the one or more keywords; and
modifying the search result UI element to represent an updated result of the search based on the second keyword.

4. The method of claim 1, wherein the identifying the target scene comprises:
extracting one or more still cuts from a copy of at least a portion of the video;
displaying, within the keyword search UI a still cut UI element representing the one or more still cuts and a selection UI element for selecting one still cut from among the one or more still cuts;
obtaining, from the user, an input instructing to select a first still cut; and
identifying a scene corresponding to the first still cut among the one or more still cuts as the target scene.

5. The method of claim 1, wherein the identifying the target scene comprises:
extracting one or more still cuts from a copy of at least a portion of the video;
transmitting the one or more still cuts to a user terminal;
receiving, from the user terminal, selection of a second still cut among the one or more still cuts; and
identifying the second still cut as the target scene.

6. The method of claim 1, wherein the identifying the target scene comprises identifying a scene displayed at a time point when the request for searching for the content of the video is received as the target scene.

7. The method of claim 1, wherein the collecting the metadata comprises:
analyzing an electronic program guide (EPG) associated with the video;
analyzing one or more overlays included in the content of the video from the target scene,
collecting information about the video based on the one or more overlays; or
performing a search for the content of the video.

8. The method of claim 1, wherein the extracting the scene information comprises:
inputting the target scene to a vision-language model (VLM); and
obtaining scene description information for the target scene from the VLM.

9. The method of claim 1, wherein the extracting the scene information comprises:
performing automatic speech recognition (ASR) with respect to a first section of the video including the target scene; and
obtaining text data corresponding to voice data included in the first section based on the performing the ASR.

10. The method of claim 1, wherein the extracting the scene information comprises:
detecting one or more objects from the target scene; and
obtaining a list of the one or more objects based on the detection of the one or more objects.

11. The method of claim 1, wherein the extracting the scene information comprises:
recognizing one or more faces included in the target scene based on the metadata; and
obtaining information about the one or more faces.

12. The method of claim 1, wherein the generating the one or more keywords comprises:
inputting the metadata and the scene information to a language model; and
obtaining the one or more keywords from the language model.

13. The method of claim 1, further comprising transmitting at least one of the one or more keywords to a user terminal.

14. A non-transitory computer-readable storage medium having stored thereon instructions that, when executed by a processor, cause the processor to:
receive, from a user, a request to search for content of a video;
identify, from among a plurality of scenes included in the video, a target scene associated with the request;
collect metadata associated with the video;
extract scene information representing the target scene based on the metadata;
generate one or more keywords based on the metadata and the scene information;
perform a search based on a first keyword among the one or more keywords; and
control a display to display a keyword search user interface (UI), the keyword search UI comprising a search result UI element that represents a result of the search based on the first keyword.

15. An electronic device comprising:
at least one processor including processing circuitry;
memory including one or more storage media storing one or more instructions;
a communication interface configured to perform communication with an external device; and
a display configured to display a video,
wherein the one or more instructions, when executed by the at least one processor individually or collectively, cause the electronic device to:
receive, from a user, a request to search for content of the video;
identify, from among a plurality of scenes included in the video, a target scene associated with the request;
collect metadata associated with the video;
extract scene information representing the target scene based on the metadata;
generate one or more keywords based on the metadata and the scene information;
perform a search based on a first keyword among the one or more keywords; and
control a display to display, a keyword search user interface (UI), the keyword search UI comprising a search result UI element that represents a result of the search based on the first keyword.

16. The electronic device of claim 15, wherein the one or more instructions, when executed by the at least one processor individually or collectively, further cause the electronic device to:
obtain, from the user, an input for selecting a second keyword among the one or more keywords; and
modify the search result UI element to represent an updated result of the search based on the second keyword.

17. The electronic device of claim 15, wherein the one or more instructions, when executed by the at least one processor individually or collectively, further cause the electronic device to:
analyze an electronic program guide (EPG) associated with the video;
analyze one or more overlays included in the content of the video from the target scene;
based on the one or more overlays, collect information about the video; or
perform a search for the content of the video.

18. The electronic device of claim 15, wherein the one or more instructions, when executed by the at least one processor individually or collectively, further cause the electronic device to:
obtain scene description information for the target scene by inputting the target scene to a vision-language model (VLM);
obtain text data corresponding to voice data included in a first section of the video including the target scene based on performance of automatic speech recognition (ASR) with respect to the first section;
detect one or more objects from the target scene; or
recognize one or more faces included in the target scene based on the metadata.

19. The electronic device of claim 15, wherein the one or more instructions, when executed by the at least one processor individually or collectively, further cause the electronic device to:
input the metadata and the scene information to a language model; and
obtain the one or more keywords from the language model.

20. The electronic device of claim 15, wherein the one or more instructions, when executed by the at least one processor individually or collectively, further cause the electronic device to transmit at least one of the one or more keywords to a user terminal via the communication interface.
